(19) United States
(12) Patent Application Publication
(10) Pub. No.: US 2004/0225658 A1
(43) Pub. Date: Nov. 11, 2004

(54) Network-based document management systems

(76) Inventor: Felix Horber, Zug (CH)

Correspondence Address: SHAW PITTMAN LLP, 1650 TYSONS BOULEVARD, MCLEAN, VA, 22102, US

(21) Appl. No.: 10/775,184

(22) Filed: Feb. 11, 2004

Related U.S. Application Data
(60) Provisional application No. 60/446,996, filed on Feb. 13, 2003.

(51) Int. Cl. G06F 7/00

(52) U.S. Cl. 707/9

(57) ABSTRACT

Systems and methods for managing electronic dossiers each having one of a plurality of document formats, wherein the electronic dossiers are accessible by a plurality of web site users via a computer network. An embodiment of the method includes selecting an electronic dossier for conversion; obtaining, from a predetermined set of templates, a template associated with the format of the dossier; obtaining, from a predetermined set of styles, at least a subset of style characteristics to be correlated to the format of the dossier; converting the dossier to a document platform having a unified format; storing the converted dossier together with the obtained template and the obtained style subset in a unified database; and providing access to the unified database to a plurality of users through a computer network browser interface in order to at least one of process, view, and store the converted dossier.

This application claims the benefit of U.S. Provisional Application No. 60/446,996, filed Feb. 13, 2003, which is herein incorporated by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### FIELD OF THE INVENTION

The present invention relates to a network-based document management system. More particularly, the invention relates to the control and to the configuration of network components that co-operate to generate, process and provide data originating from various sources to a number of users.

### BACKGROUND OF THE INVENTION

Modern communications networks like the public Internet, non-public intranets or combinations thereof have greatly facilitated the presentation and the exchange of information to/between large user groups. The facilitated information exchange, however, necessitates an improved information management to cope with issues like lack of accessibility of information, sub-optimal speed of information retrieval, unnecessary duplication of processes and information, etc. It is obvious that due to the steadily increasing amount of information to be managed, the task of information management becomes increasingly laborious.

To facilitate the task of information management, numerous standard platforms have been developed. As an example for such a standard platform, Lotus Domino R5 distributed by Lotus/IBM Inc. can be mentioned. Despite the availability of such standard platforms, the existence of individual needs still requires complex considerations for example regarding network technologies and topologies, regarding the programming and interconnecting of network components and regarding the distribution of specific processing tasks among the individual network components.

Information to be processed by individual network components can relate to various aspects and usually the above considerations of a network technologist are independent from the specific nature of the processed information. However, there exist situations in which the nature of the processed information does influence technical aspects of the communications network and its components. In such a case, it becomes essential that the technical environment including network topology, user interfaces, etc. is adapted to the specific type of information to ensure a proper, efficient and secure operation of the communications network. This holds true for, among others, information relating to tasks, processes or events, but also to data reflecting the structure, the incorporation and the executives of an organization and the definitions and procedures according to which this organization implements and carries out its business.

There is a need for a technical environment that allows for an improved information management. More specifically, there is a need for appropriately configured network components and a method of controlling such network components that allow for a fast, efficient, and secure processing of information the above-mentioned kinds.

This holds especially true when in a large—and often times geographically and structurally distributed—organization that exists for a long period of time, several content providing network systems serving different and/or overlapping purposes and user groups of the organization, coexist within said organization.

### PROBLEM UNDERLYING THE INVENTION

A major technical problem resides in the fact that there is a constant change within the organization, departments, working groups, project groups are formed and disbanded, new information technology (IT) hardware and software has to be provided to such units in the organization and maintained in an operative state during the existence of said units. This is a very manpower-intensive and laborious task as many of the various content providing network systems in organizations heretofore have different user interfaces, require special client software on the user side and are to be updated when new software releases are available. Further, special client software required on the users' workstations demands increased hardware capabilities (storage capacity, working memory, processing capacity etc.) on the users' workstations. Also, the users have to be trained in use the of the software packages having disparate user interfaces due to their different origin and purposes.

Another aspect of the technical problem underlying the invention is the storage and the maintenance and the dissemination or presentation of the electronic dossiers available in an organization. Usually, the documents can be statically or dynamically created inside or external to the organization, range in their complexity from simple alphanumeric and/or graphic documents to complex applications requiring data input by a user and/or data import from other documents or data sources (internet, intranet) during the utilization of the document by a user. Creating, maintaining and updating this vast variety of different kinds of documents, web pages and data complications is very cumbersome and requires extensive IT skills.

### BRIEF SUMMARY OF THE INVENTION

According to an aspect of the invention, this need is satisfied by a network component adapted to be connected to a number of members of a group of network components in a computer network for a unified network-based document management comprising a hosting unit for hosting for access by the group of network components at least a program code portion for generating one or more graphical user interfaces (GUIs), one of said graphical user interfaces having at least a control element for initiating a transformation of an electronic dossier originating from one of a number of document platforms, said electronic dossier being provided in a first format and being made available to a number of users of a web site; a program code portion for obtaining from a predetermined set of templates one template to be correlated to the data of said electronic dossier, for obtaining from a predetermined set of styles at least a subset of style characteristics to be correlated to the data of said electronic dossier, for migrating said electronic dossier to a document platform having a unified format, and for electronically exporting said electronic dossier together with said suited template and said style subset to a unified database, wherein said unified database is adapted to store said electronic dossier together with said obtained template and said obtained style subset and is accessible by a user by means of one of said network components through a browser interface by means of a browser installed on at least said one network component in order to process, view and/or store said electronic dossiers.

### PROPERTIES, ADVANTAGES AND ENHANCEMENTS OF THE INVENTION

The invention allows for a completely web-based creation, authoring, maintenance and managing environment for a wide variety of documents avoiding special client software that is very costly and requires a long lead time for its installation as well as differing hardware configurations on the user workstations' side. Rather, the utilization of identical client workstations having reduced processing storage and working memory capabilities significantly facilitates the effective setup, change, and dissolution of working units within the organization.

The contents of the unified information platform are bundled into sites. A site of the unified information platform corresponds to the site concept as commonly found on the Internet. A site of the unified information platform is a collection of hierarchically organized pages describing for instance a product, a service, a process, or an organizational unit.

This is in contrast to currently available portals appearing as one big site with many entry points. Borders between different kinds of information are unclear, which is mostly due to the common navigation on every page and the large number of links in the local navigation and in the content that lead away from the actual site.

The concept of the present invention approaches this problem in that it isolates different types of information from each other. A site of the unified information platform is a capsule of a specific kind of information. The local navigation on a site exclusively contains links internal to this site. Links that point outside a site can only be placed in the content area or in a special area of the local navigation. Such links, which can point either to other sites of the unified information platform, the rest of an intranet or the Internet, are marked with an icon, thus helping the user to get a better sense of orientation.

The invention also allows for a clear separation of the page contents from the design rules and the template rules and any proprietary elements of the unified document platform. This minimizes the memory requirements and the software overhead on the server's as well as on the user workstations' side. Further, this invention reduces the efforts for training of the users due to the uniform man-machine-interface for all the documents previously available only through different user interfaces, it enhances the ease-of-use and contributes to a coherent presentation of the contents.

Further, the invention allows for very flexible navigation modes (e.g., by action, item or by topic) due to the consistent storage, retrieval and processing-further of electronic dossiers in the unified database.

The number of document platforms from which said electronic dossiers may originate include: HTML pages, database contents plus templates, static web pages, documents comprising alphanumeric and/or image data, links to other web sites, XML documents, or the like.

The computer network comprises a number of groups maintaining different sets of document platforms. This allows for different organizational or business units of an organization or corporation to host their entirety of information in a unified IT environment. This also contributes to the reduction of costs of hardware and/or software infrastructure.

In order to have clear interfaces, competences and rules related to the unified database, several functions having predetermined authorities, tasks and capabilities are provided: a platform manager function, a web manager function, a site manager function, a publisher function, site owner function, and an author function.

Most of these authorizations, tasks, and capabilities are implemented by access rights (read, write, modify, create etc.) to documents, web pages and web sites.

Another important aspect of the invention resides in the circumstance that each template of said predetermined set of templates is comprised of at least three distinct areas accessible through said GUI: a top area comprising at least one pointer for a global navigation path, and/or at least one pointer for a global topic; and/or at least one pointer for a global function; a local navigation area comprising at least one pointer for a local navigation path having a predetermined maximum hierarchical navigation depth! and/or at least one pointer for a local page of the web site, and/or at least one pointer for an page of an external web page, and/or at least one micro-identity area;

and a content area having a predetermined layout according to said predetermined set of styles. This allows for a consistent appearance of the data to the user “look and feel” facilitating the navigation and retrieval of the contents by the users.

A publishing function of a web site has complete control over the structure of the local navigation of a site. It can add and delete navigation entries, create links between navigation entries and pages (whether inside the site or external to it), edit navigation entries, and set up navigation titles and catalogues.

The design of the navigation is standardized. The colors, fonts, and spacing are all controlled by the system. Certain other items are also fixed. Every local navigation, for instance, has an entry called Top. This is the root navigation of the site. Top is always linked to the welcome page of a site. When a user accesses a web site, he or she sees the Top navigation and its page first. Via the publishing function, the page that is linked to the Top navigation may freely be changed, but there must always be a page linked to Top. The text of the Top entry cannot be deleted or changed (it is always called Top, in all languages).

The navigations are hierarchical. There is a vertical and a horizontal hierarchy. Vertically, the Top navigation is always the first entry, and there is always space between the Top navigation and the rest of the navigation entries. Navigation entries can be included under Top. Horizontally, navigations may be up to four levels deep. For example, a small triangle icon pointing left next to a navigation entry indicates that there are sublevels hidden underneath it. Clicking on the entry ‘opens’ the navigation to display the first sublevel. As another example, triangle pointing down and a different color indicate an open navigation. An empty square indicates a navigation without subentries.

Several different navigation types are made available:

NAVIGATION: A normal navigation is a navigation linked to a page in the unified database platform (typically in the same site, may however also be a page in another site).

LINK: A navigation link is a navigation that points to a page outside of unified database platform (typically in the internet or an application accessible on the intranet).

TITLE: A navigation is a navigation element that is not linked to anything. It appears bold in the navigation and is used to divide a long navigation into sections.

CATALOGUE: A catalogue navigation is a special navigation entry that brings up a pre-defined, searchable list of sites.

In a preferred embodiment, different links are made available. Some are indicated in the table below:

| Link Name | Link Type | Description |
|---|---|---|
| Doc-Web- | Document | Links to documents in DocWeb. |
| Document Link | | |
| Non-Doc- | Document | Links to documents on a web server. |
| Web Doc. Link | | |
| Internal Site | Page | Links to the Welcome Page of a site |
| Link | | (independent of which page is currently the |
| | | Welcome Page). |
| Internal Link | Page | Links to a page in the unified database. |
| Internet Link | Page | Links to a page in the internet. |
| Org. Unit | OU | Links to an OU's entry in Who-is-Who |
| Link | | and its Welcome Page (if available). |
| Person Link | Person | Links to a person's entry in Who-is-Who and |
| | | a related web page (if available). |
| Email Link | Person | Allows the user to send an email to a |
| | | Specific person. |
| | | The Email may be preformatted. |
| SMS Link | Person | Allows the user to send an SMS |
| | | to a specific person |
| | | (over a message service). |
| Company | Company | Links to a company's web page. |
| Link | | |

Links can be displayed in the conventional manner of the internet (e.g., blue underlined text, which turns purple if the link has been used once). According to the present invention, links differ from internet (HTML-based) links in several aspects. Links can contain optional information besides the link text. This information is often supplied by the system, in some cases is added by the publishing function. For example, the size of the document, the language and the icon of the software program used to generate, modify, or display the document are supplemental information. The publishing function can choose to display such information or not. The link text can also be changed by the publishing function.

Some links can point simultaneously to multiple targets. A company link, for example, can point simultaneously to a company's home page and to its entry in a database, in an application available through the intranet, or the like.

Linking to a wide variety of documents (PDF, WinWord, Excel, PowerPoint, Visio, etc.) can be provided in the unified database according to the present invention. When the user follows a document link, the document will open. The document must be either available via an intranet or reside on a web-server which is available to the unified database (i.e., it must have a URL).

The design rules utilized to create and format include the text font, the font size and colors on pages on blocks and properties like titles, subtitles, text etc., adjusts spacing between elements like text lines, between text and graphic elements, define colors for backgrounds, and exclude the utilization of animations or the like.

Each of said electronic dossiers in said unified database is organized as a part of a collection of hierarchically organized pages forming a site describing a product, a service, a process or an organizational unit.

Each of said migrated electronic dossier uses XML as the unified format, and wherein the contents is stored in the form of information blocks which are independent from the design or the layout of the contents. This allows for a wide variety of presentation media for the contents (intranet, internet, print, sound, etc.).

A further program code portion can be provided for checking and verifying the contents of the electronic dossier with regard to its accuracy, timeliness, and relevance to the site prior to its migration to the document platform having the unified format. This functionality significantly reduces the amount of data to be migrated. Further, it has a positive effect on the acceptance and quality and the value of the unified database for its users.

A preferred embodiment comprises a program code portion automatically effecting a language management function that substitutes a web page not existing in a certain requested language by an available language version of this web page according to a predefined priority scheme. The language management function interacts with the database on the site level. The site administrator function declares which languages are supported on a site of the uniform document database platform. The language navigation on every page indicates the currently chosen language and the available languages. The site administrator function ascertains that all pages are available in all declared languages. If a given page is not available in a declared language, it will be displayed in another language in a certain predetermined order, e.g., German—English—French—Italian. This order can be defined differently for different sites. The result is a page with the navigational elements in the chosen language and the content in a substitute language. When navigating within a site, a user does not drop out of the chosen language context. This also means that the complete wording (navigational elements, help texts etc.) on the site is provided in these four languages. Individual pages can also be added in other languages, e.g., Spanish and Portuguese.

The wording is implemented as a dictionary, making it possible to rapidly add new languages whenever this is required.

Further, a program code portion can be provided that automatically effects a receiving of feedback information about a web page or a web site from a user, and a routing of said feedback information to a feedback database accessible by the responsible of such web page or a web site, and an entering of said feedback information into said feedback database.

This can be implemented by a link to said feedback database provided, for example, in the footer of each page presented to a user. Users may click on this link and then are able to write and send comments on the page. This feedback function allows users to send comments about the pages they are looking at to the publishing function of the respective pages. This can be very useful in maintaining the quality of the web pages. The comments or messages go directly into a message center of the web site to which the page belongs. Depending on the property settings, an email notification may be sent to all the site managing functions and/or publishing function on the site to alert them that a new comment has arrived. This email notification contains a link to the comment and a link to the page that generated the comment. The feedback information can be accessed (read) by the publisher and/or the site manager function in order to be processed (a bug fixed, a request being answered, an update of data provided, etc.).

Further, a program code portion can be provided, allowing for access of web sites or web pages to an integrated image library, with the integrated image library preferably having a hierarchical organization allowing for the distinction of globally valid images from those that are to be used only within one site.

This feature can be implemented by a link from said web page or web site to an image in said integrated image library, or by an actual copy of an image put into said web page or web site.

Via the publishing function, images can be uploaded into the integrated image library database. Certain meta data for each uploaded image must be provided. These are: Name, Description, Keywords, and Type. The image type is chosen from a pre-defined list. Only images in certain formats are accepted. When an image is uploaded, the image is given a unique ID number. Further, the dimensions (the length and width of the image measured in pixels), the size, the mime-type (either GIF or JPG) are figured out. Also, the creator and/or last modifier of the image is stored together with the image. All images are associated with a specific site. This is the site that the publisher was in when the upload was performed. The publishing function that uploaded the image indicates if the image may be used on other web sites or not. If the publishing function qualifies the image as shared, it is available to all sites in the unified database. If the publishing function qualifies the image as private, it is only available on the site on which it was uploaded (it is however available to all the publishing functions on that site, and can be used on any page in that site). It cannot be used on other sites.

The unified database can also provide access to set of global images, which are images made available by the organization to all web sites of that organization. Only through Platform Managing function, global images can uploaded. Only the uploading function may effect changes to the meta data of the image. In order to modify the image itself, an image editor must be used. If such changes to an image do not affect the dimensions of the image (e.g., the length and width remain the same), it may be resubmitted to the database under the same name and ID number. If the changes affect the dimensions of the image, then it must be uploaded anew into the database. An image may only be deleted from the database when it is not being used on any pages. Altering an image and resubmitting it under the same ID number such that the image may be being used on various different pages, will affect those pages as well. A list of all pages where the image is used is maintained in the database.

In a preferred embodiment, a program code portion may be provided effecting automatic checks of links used in the document or web page depending on the link type, and/or automatic content expiration of web pages or web sites, and/or automatic detection of orphaned contents or sites, and/or automatic detection of accounts of users trying to access web pages or web sites the authorization of which has expired.

Such an integrity checker is used to check the links on a page. This avoids broken and non-functioning links.

A daily check can be effected on all live, unfinished-live, and finished-live pages that have been modified or created during the last calendar day.

A complete check can be effected weekly on all live, unfinished-live, and finished-live pages. This check can be run once a week in the night from Saturday to Sunday.

An interactive single page check can be effected at any time with the Check Integrity command a publishing function can check the page currently being worked on.

The link checker looks at the following tags on the page: document tags—the document types docweb, attachment, and URL are checked. Link tags—the link types internal, wip, wip-info, bankweb, and bankweb-info are checked.

There are four possible results of a check:

OK—the link, document or person reference could be checked successfully,

NOT CHECKED—the link, document or person reference could not be checked, for instance because hardware or software infrastructure required to carry out the check are down.

WARNING—the link functions, but there is an incorrect attribute somewhere (for example, an internet link with a intranet URL).

ERROR—the link, document or person reference has a problem that must be fixed by the publishing function; in this case, the link does not function at all.

Depending on its findings, the link checker sets an integrity flag of a page to the following values: GOOD—no problematic link, document or person reference found on the page; WARNING—one or more warnings found; and CORRUPT—one or more errors, and maybe additional warnings, found.

In a preferred embodiment, a program code portion may be provided effecting an automatic scanning of migrated electronic dossiers for extracting document related meta information (page ID, page title, edit (live link to page), page type, URL, page description, keywords, language, last modified by, last modified date, expiration date, created by, creation date, state), and an automatic attaching of said extracted document related information to said document for search and retrieval by users of said unified database.

The invention is further concerned with a computer database product for a unified network-based document management comprising at least one electronic dossier originating from a document platform, each of said dossiers being provided in a unified format together with at least a subset of style characteristics of a predetermined set of styles to be correlated to the data of said electronic dossier and one template of a predetermined set of templates to be correlated to the data of said electronic dossier, for being accessible by a user by means of a network component through a browser interface by means of a browser installed on at the network component in order to process, view and/or store said electronic dossiers.

This aspect of the invention becomes important after the existing electronic dossiers have been processed by a network-based document management system as described above, and when new dossiers are to be created and added to the then existing unified database platform.

In such a computer database product for such a unified network-based document management, each template of said predetermined set of templates is comprised of at least three distinct areas accessible through a graphical user interface: a top area comprising at least one pointer for a global navigation path, and/or at least one pointer for a global topic; and/or at least one pointer for a global function; a local navigation area comprising at least one pointer for a local navigation path having a predetermined maximum hierarchical navigation depth, and/or at least one pointer for a local page of a web site, and/or at least one pointer for an page of an external web page, and/or at least one micro-identity area; and a content area having a predetermined layout according to said predetermined set of styles. This allows for a consistent appearance of the web pages and the web sites in accordance with said computer database product to the user facilitating the navigation and retrieval of the contents by the users.

Also, in the computer database product according to the invention, the design rules utilized to create and format include the text font, the font size and colors on pages on blocks and properties like titles, subtitles, text etc., adjusts spacing between elements like text lines, between text and graphic elements, define colors for backgrounds, and exclude the utilization of animations, or the like. Each of said electronic dossiers in said unified database is organized as a part of a collection of hierarchically organized pages forming a site describing or representing a product, a service, a process or an organizational unit.

The electronic dossiers use XML as the unified format, and the contents of said electronic dossiers is stored in the form of information blocks which are independent from the design or the layout of the contents. This allows for a wide variety of presentation media for the contents (intranet, internet, print, sound, etc.).

The computer database product according to the invention is accessible by a platform manager function, a web manager function, a site manager function, a publisher function, site owner function, and an author function.

The migration and/or the generation of the documents to be provided and made accessible through the unified database can be a browser-based content management application used and accessed by the publisher function, the site administrator function, the site owner functions, and the administrator functions. A main design principle is that no advanced IT or programming skills are required. The basic unit of publishing is a paragraph, and not a complete page as in conventionally available web publishing software packages. Paragraphs are added to a page, are reordered, are modified, and/or deleted. For every paragraph type, there is a dedicated editing functionality that hides most of the underlying markup code. An XML DTD (Document Type Definition) is defined for the page content which defines exactly what kind of markup is allowed in which paragraph. Whenever a paragraph is saved, its content is checked against the Document Type Definition, and it is refused if it violates the DTD.

There are multiple benefits of storing content in XML:

XML markup allows assigning special meaning to content. An example for this is link handling and tagging in the database (people links, document links etc). This is not possible in plain HTML.

A unified look and feel of all pages on the uniform document database platform can be implemented down to paragraph level.

Since XML to HTML conversion is completely in the hand of the uniform document database platform, it is possible to migrate content to new versions of HTML and to new browsers without involving the publishers.

Mobile intranet access via WAP can be implemented. This only requires XML to WML conversion.

Conversion of intranet content to PDF, for instance, for proofreading purposes.

Most presentation issues are handled by the uniform document database platform, allowing the publishing function to concentrate on content-related issues.

Text within a web page can have the following style effects:

| Format | Semantic | Tag Effect |
|---|---|---|
| Important | <strong>...</strong> | Example: <strong>STRONG</strong> |
| | | This serves to set words or phrases apart |
| | | from each other visually. Currently, “strong” |
| | | tagged elements are rendered bold. |
| Emphasis | <em>...</em> | Example:<em>EMPHASIS</em> |
| | | This emphasizes words or phrases. |
| | | Currently rendered in italics. |
| Line Break | <br> | Example: LINE <br/> Break |
| | | As in HTML. Note however the backslash |
| | | after the br. It is also possible to add type br |
| | | without the backslash. |
| Subtitle | <subtitle>...</subtitle> | Example: <subtitle>SUBTITLE</subtitle> |
| | | Used to add a subtitle into text. Subtitles are |
| | | rendered on a new line with a blank line |
| | | above and below. |
| Superscript | <sup> ... </sup> | Example: <sup>SUPERSCRIPT</sup> |
| | | Used to make superscript text. |
| Subscript | <sub> ... </sub> | Example: <sub>SUBSCRIPT</sub> |
| | | Used to make subscript text. |
| Code | <code> ... </code> | Example: <code>CODE</code><br/> |
| | | Used to make a computer code-like, fixed font. |
| UBS Tiny | <style class=“ubstiny”> | Example: <style class=“ubstiny”>This is |
| | ...</style> | UBS tiny text.</style> |
| | | Used to put text into a small typeface. |

The computer database product according to the invention may further comprise a program code portion automatically effecting a language management function that substitutes a web page not existing in a certain requested language by an available language version of this web page according to a predefined priority scheme.

Further, the computer database product can comprise a program code portion automatically effecting a receiving of feedback information about a web page or a web site from a user, and a routing of said feedback information to a database accessible by the responsible of such web page or a web site, and an entering of said feedback information into said database.

Further, the computer database can comprise a program code portion providing access of web sites to an integrated image library, with the integrated image library having a hierarchical organization allowing for the distinction of globally valid images from those that are to be used only within one site.

A program code portion effecting automatic checks of links depending on the link type, and/or automatic content expiration of web pages or web sites, and/or automatic detection of orphaned contents or sites, and/or automatic detection of accounts of users trying to access web pages or web sites the authorization of which has expired may be provided to increase the accuracy of the database contents.

Further, the computer database product may comprise a program code portion effecting an automatic scanning of electronic dossiers for extracting document related meta information, and for automatic attaching of said extracted document related information to said document for search and retrieval by users of said unified database.

The publishing function may only view (read) such meta information. It can be modified by the site managing function. The meta information describes the site properties, controls basic site parameters and site-wide meta information, as listed below:

| | |
|---|---|
| State | State of site. |
| Site ID | ID Number of site (system-generated). |
| Site name | Name of Site. |
| Site qualifier | Alias function (text-based URL for the site). |
| Site OU | Organization Unit of site. |
| Division | Division of site. |
| Site type | Type of site. |
| Global navigation | The site's position in the global navigation. |
| Search collection | Position of site in the intranet Search. |
| Validity period | Default page validity within the site. |
| Access level | Open or Closed. Closed sites are CUG sites. |
| Has workflow? | Indicates if the Workflow function has been |
| | activated for the site. |
| E-Mail user feedback to | Indicates to whom the email notification of |
| | feedbacks should be sent. |
| Has news? | Indicates if the site news function has been |
| | activated. |
| Show news navigation | Places a news archive link in the local |
| | navigation. |
| Is Staging public? | Allows the staging view to be freely seen on |
| | the intranet (i.e., by nonauthorized |
| | users). URL must be communicated. |
| Site style | Style of site. |
| Site DTD version | DTD Version of site. |
| Select contact page | Sets the site contact page. |
| Categories (IT only) | Special keyword list for IT sites. |
| Name | Language-specific name of site. |
| Keywords | Language-specific keywords of site. |
| Description | Language-specific description of site. |
| Micro-ID | Site Micro-ID. |
| Creator | Creator of site. |
| Modifier | Last modifier of site properties |

Finally, the present invention is also related to a computer database product for a unified network-based document management as described above and stored on a computer readable recording medium attached to or removable from one or more of the network components.

A computer program product according to the invention comprises at least one of the program code portions and program code portions for causing one or more network components to perform the functionalities discussed above.

### BRIEF DESCRIPTION OF THE DRAWINGS

Further details, embodiments, modifications or enhancements of the present invention may be obtained from consideration of the following description of various illustrative embodiments of the invention in conjunction with the drawings in which:

FIG. 1 is a schematic diagram illustrating the data processing in accordance with an embodiment of the present invention;

FIG. 2 is a schematic diagram illustrating a network component connected to a group of network components in a computer network for a unified network-based document management comprising a hosting unit for hosting for access by the group of network components according to an embodiment of the invention;

FIG. 3 is a schematic diagram illustrating the three-layered unified network-based document database system in accordance with an embodiment of the present invention;

FIG. 4 is a schematic diagram illustrating the structure of a web page of a unified network-based document database management system in accordance with an embodiment of the present invention;

FIG. 5 are templates provided by the system that can be utilized in the unified database, in accordance with an embodiment of the present invention;

FIG. 6 is a schematic diagram illustrating the typical publishing cycle of a document on a web page of a unified network-based document database management system in accordance with an embodiment of the present invention; and

FIGS. 7 to 62 are schematic depictions of exemplary GUIs of the invention accessing a web site in the unified database.

### DETAILED DESCRIPTION OF EMBODIMENTS OF THE INVENTION

In the following, the present invention will exemplarily be set forth with respect to a web-based solution erected on a network topology that supports the implementation of a secure and reliable access control mechanism. Although the present invention is particularly suited for handling the data described herein, the network topology and access control mechanisms according to the invention can be implemented regardless of the nature of the data that are hosted, stored, processed, etc.

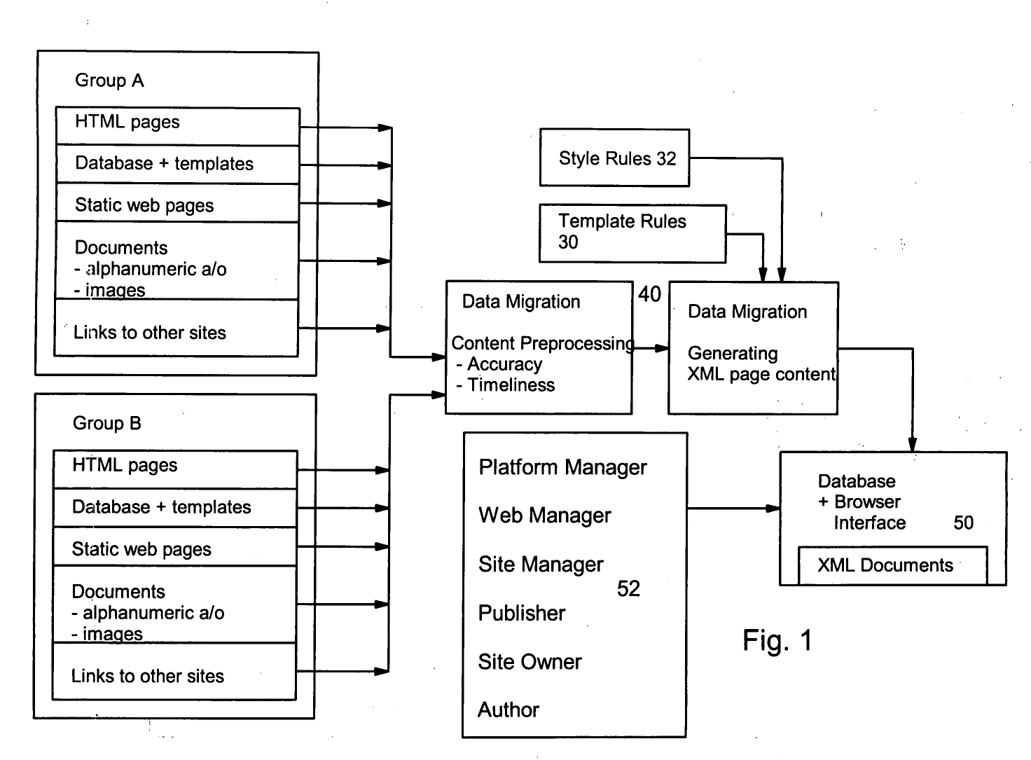

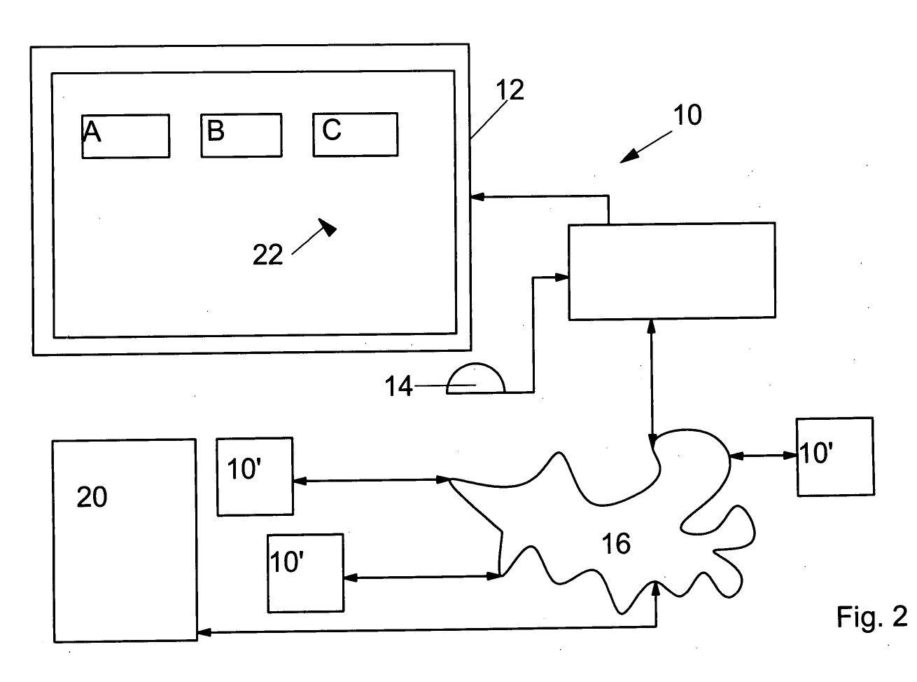

FIGS. 1 and 2 show the software and the hardware infrastructure of an embodiment of the invention utilizing a network component 10 that is a computer workstation having a graphical display unit 12 and a graphical input unit 14, e.g., a mouse. This computer workstation 10 is connected to a computer network 16 (a wide area network (WAN), a local area network (LAN) or a combination thereof, for operating an intranet and for providing access to the Internet to which a number of members of a group of similar or identical network components 10′ are also connected. In order to operate the unified network-based document management system according to the invention a hosting unit 20 that is a host server having an archival data storage is also connected to this computer network 16 for access by the group of network components 10, 10′. In addition to its server tasks, the hosting unit 20 also provides firewall functions, authenticates the distributed client components connected to the computer network 16.

On the computer workstation 10, a client software application is resident that includes a first program code portion for generating a graphical user interface GUI. The graphical user interface GUI has several control elements, that are so-called buttons (i.e., confined areas) on the display that can be operated by a mouse pointer 22 that follows the movements carried out by the graphical input unit 14.

The client software application provides a first control element, i.e., an above-described button A, on the display for activating a program code portion for electronically initiating a transformation of an electronic dossier originating from one of a number of document platforms, said electronic dossier being provided in a first format and being made available to a number of users of a web site.

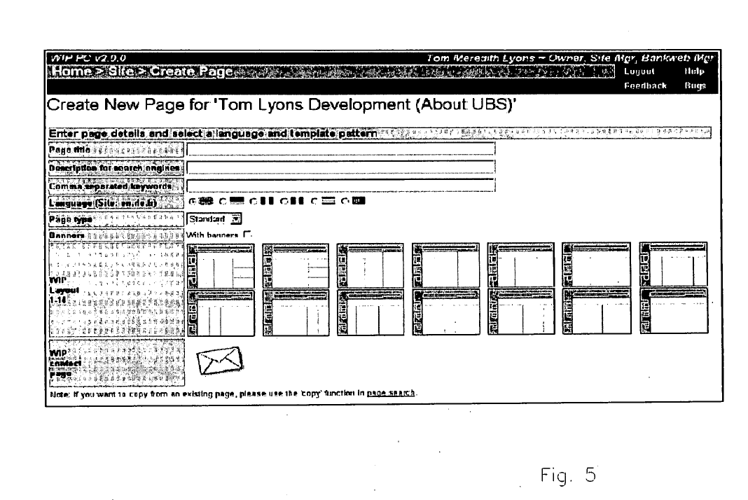

The client software application further includes a program code portion for providing a second control element B, i.e., an above-described button, on the display for electronically obtaining from a predetermined set of templates one template to be correlated to the data of said electronic dossier. The predetermined set of templates (see FIG. 5) is defined in template rules 30 and is stored in a memory accessible by the users in the computer network. Likewise, this program code portion of the client software application program includes a code portion for electronically obtaining from a predetermined set of styles at least a subset of style characteristics to be correlated to the data of said electronic dossier. Similarly, the predetermined set of styles is defined in style rules 32 and is stored in a memory accessible by the users in the computer network. The details thereof are explained hereinafter.

The client software application further includes a program code portion 40 for providing a third control element C, i.e., an above-described button, on the display for initiating an electronically executed migration of the electronic dossier to a document platform having a unified format, and for electronically exporting said electronic dossier together with said suited template and said style subset to a unified database 50. The document platforms from which said electronic dossiers may be and usually are diverse.

Especially in organizations with several business units, divisions, committees etc., the computer network is accessed and used by a number of groups maintaining different sets of document platforms. This is reflected in FIG. 1 by referring to Groups A and B each being in possession of their own electronic dossiers that may be HTML pages, database contents plus templates, static web pages, documents comprising alphanumeric and/or image data, links to other web sites, XML documents, or the like (see FIG. 1).

The unified database 50 is adapted to store the migrated electronic dossiers together with the obtained template and the obtained style subset. In one embodiment of the present invention, the migrated electronic dossiers use XML as the unified format. The contents are stored in the form of information blocks that are independent from the design or the layout of the contents.

Instead of storing the obtained template and the obtained style subset together with each of the migrated electronic dossiers, it is also possible to only store a pointer to the storage location of the obtained template and the obtained style subset together with each of the migrated electronic dossiers. In any case, the migrated electronic dossiers are accessible by a user by means of one of the network components through a browser interface by means of a browser installed on his/her network component in order to process, view and/or store the migrated electronic dossiers.

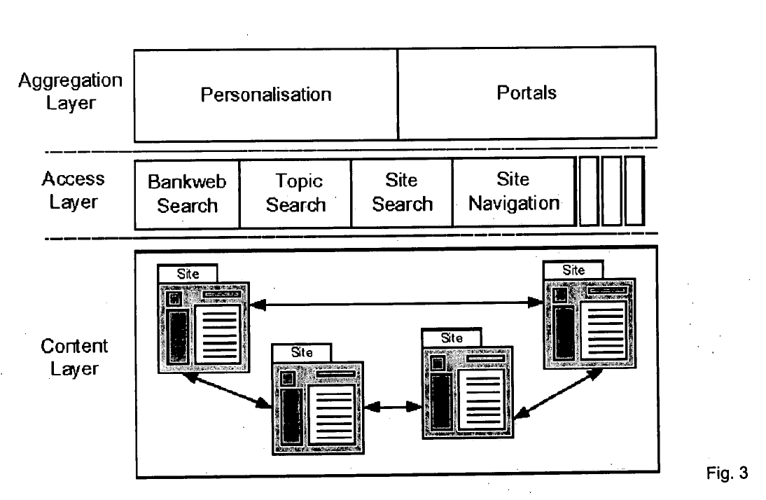

As shown in FIG. 3, the unified information platform implemented and achieved by the document database is divided into three distinct layers with defined interfaces and structures: aggregation layer, access layer and content layer.

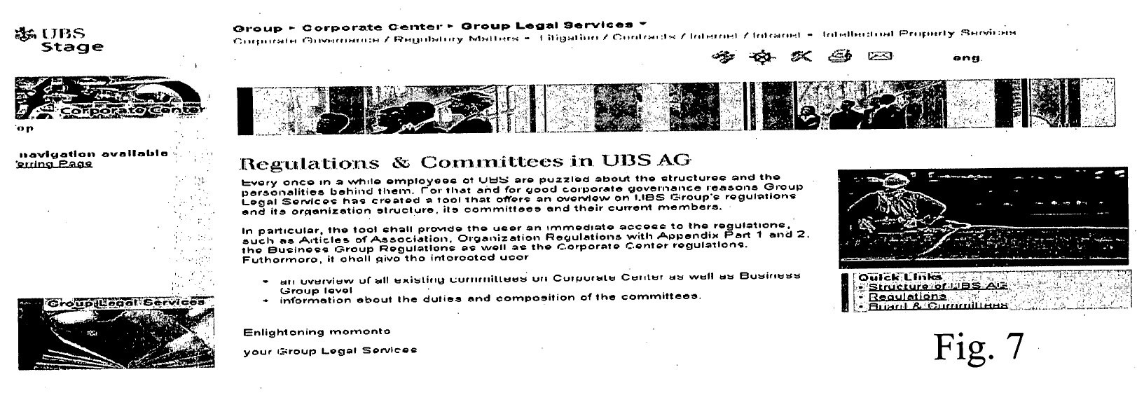

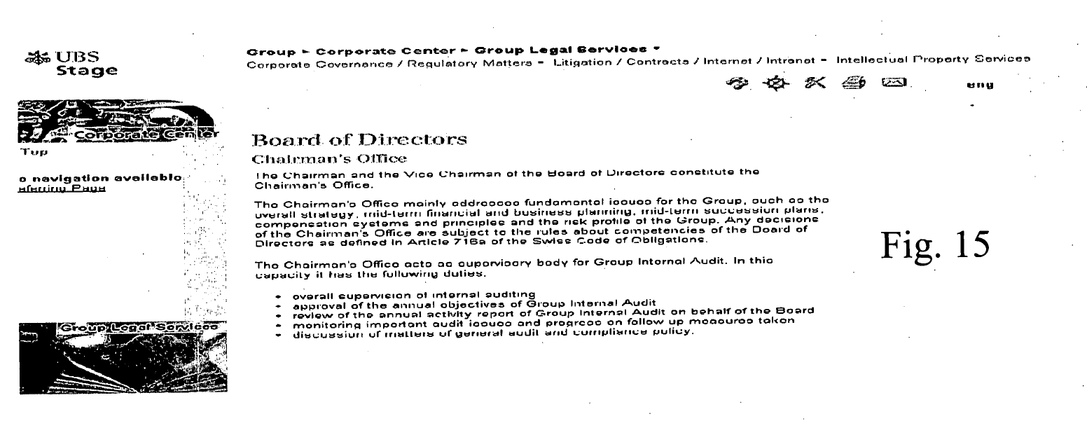

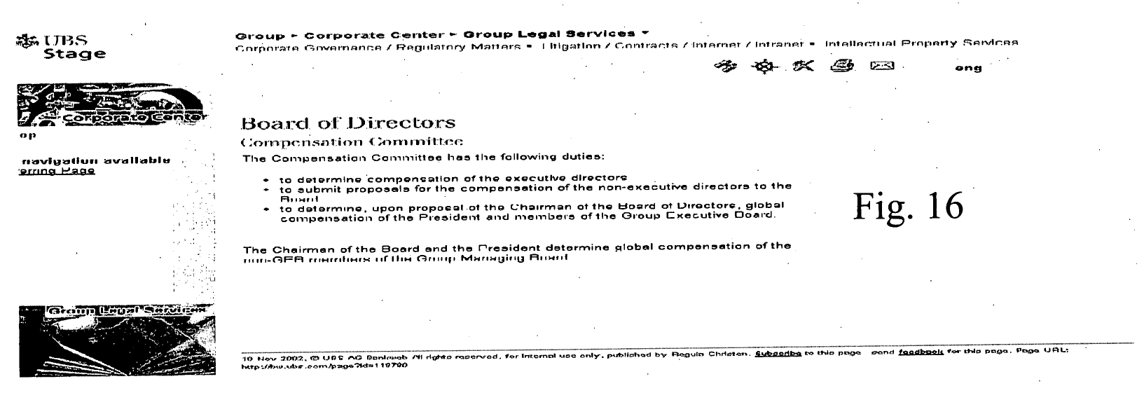

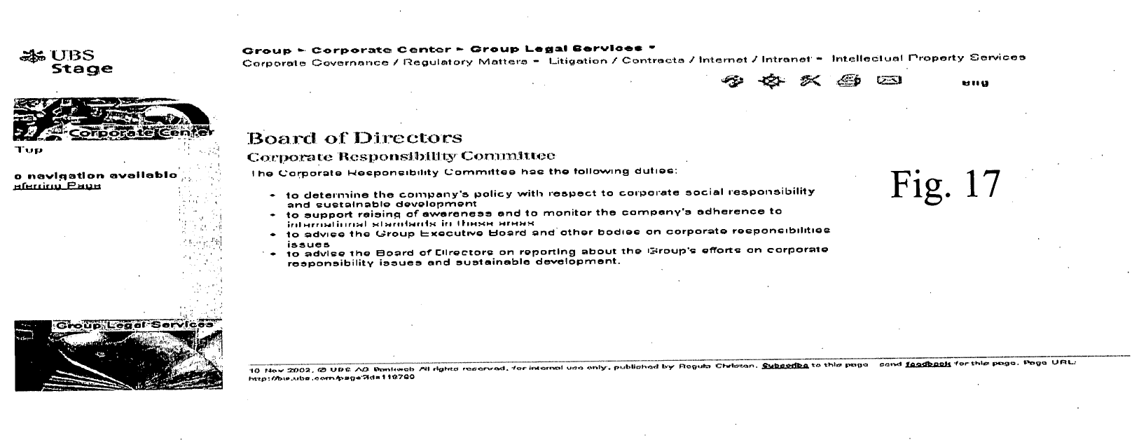

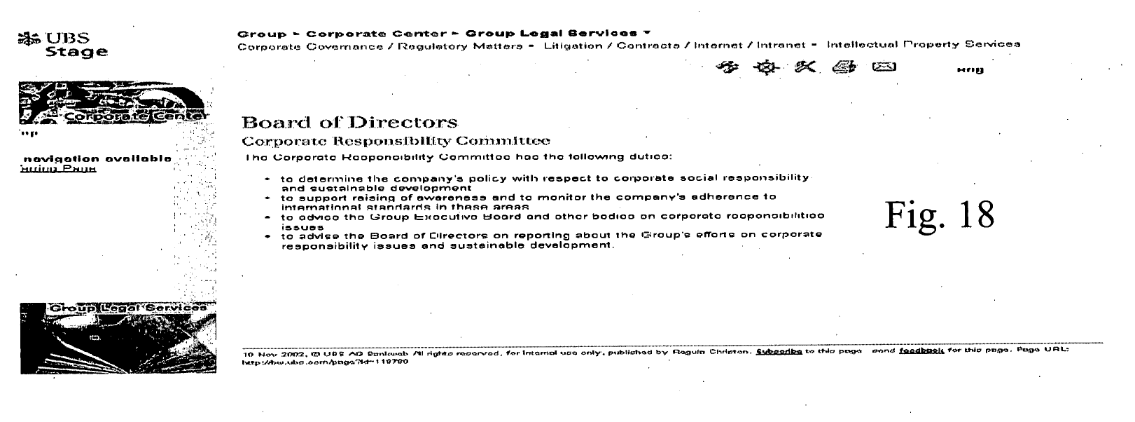

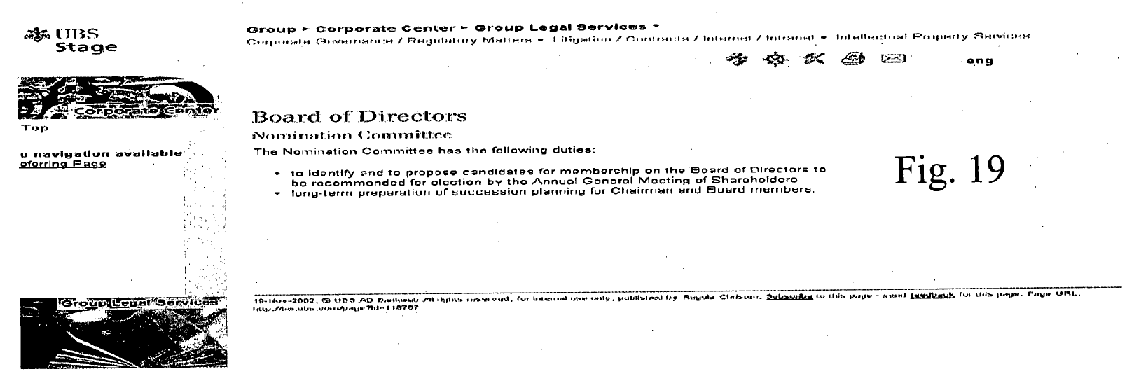

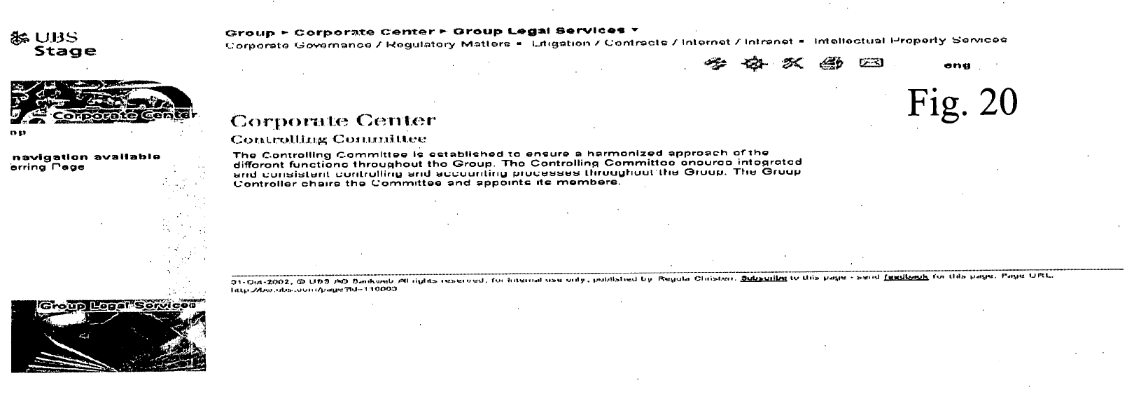

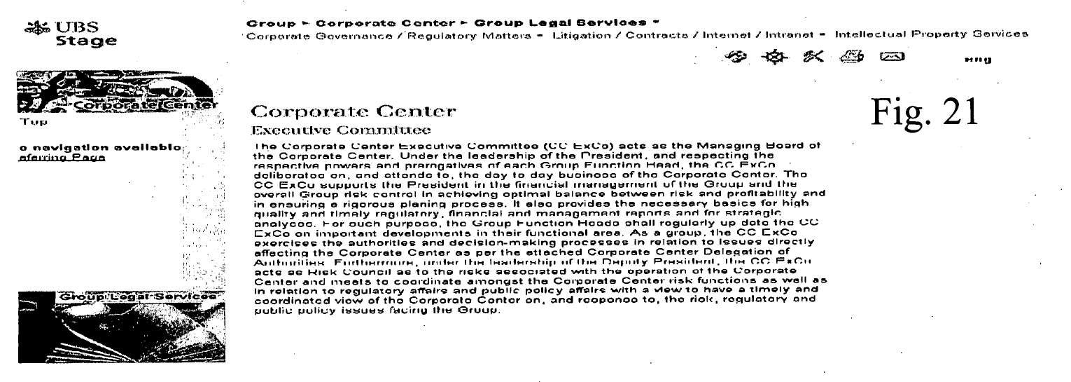

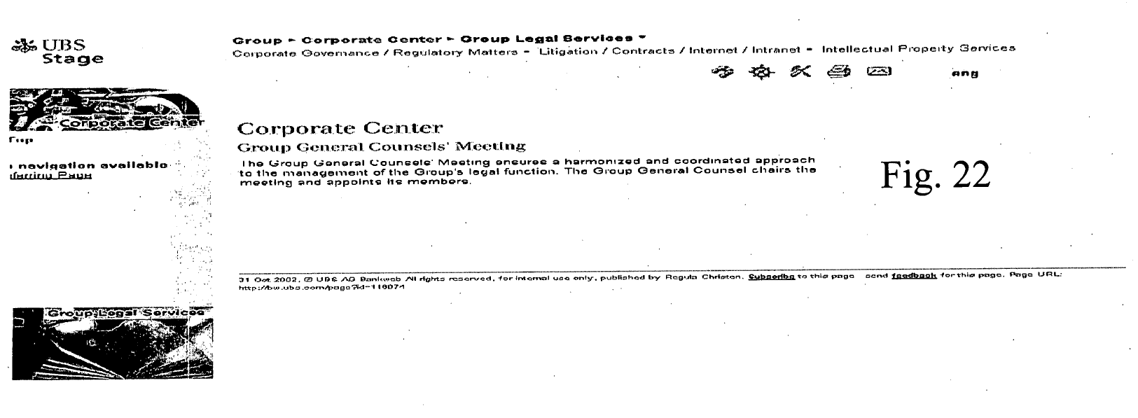

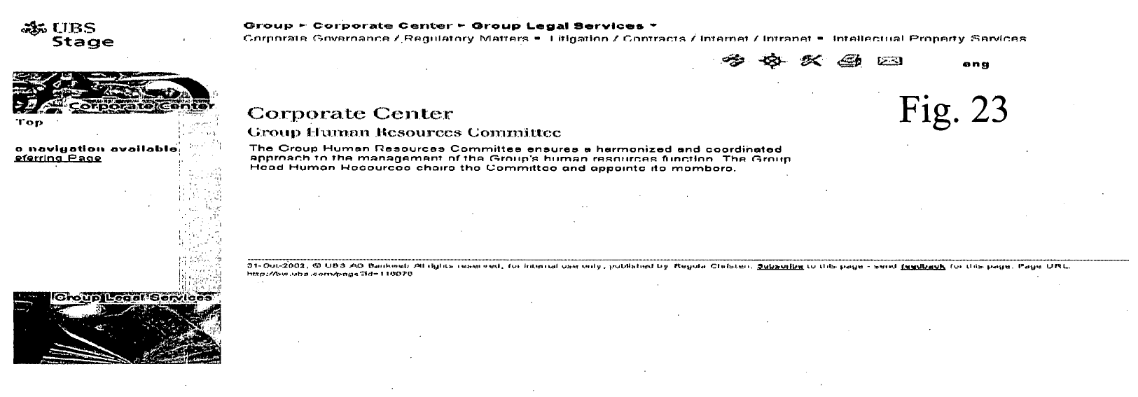

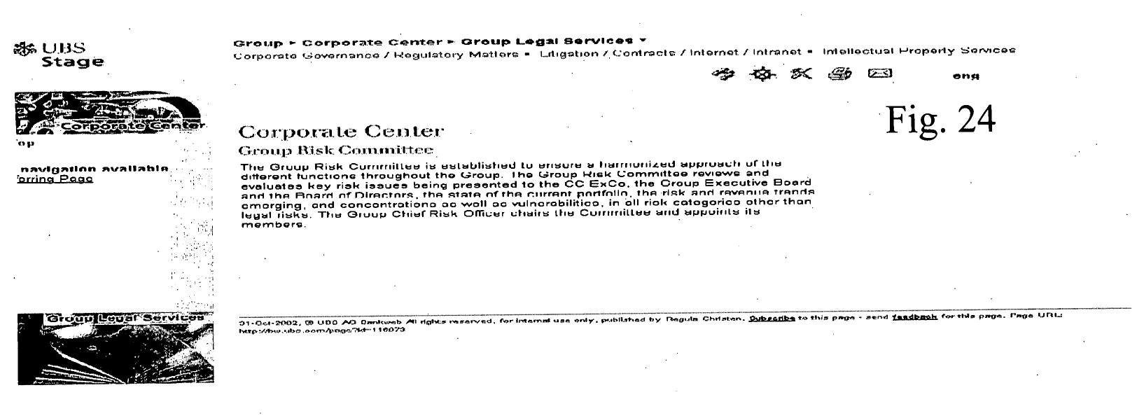

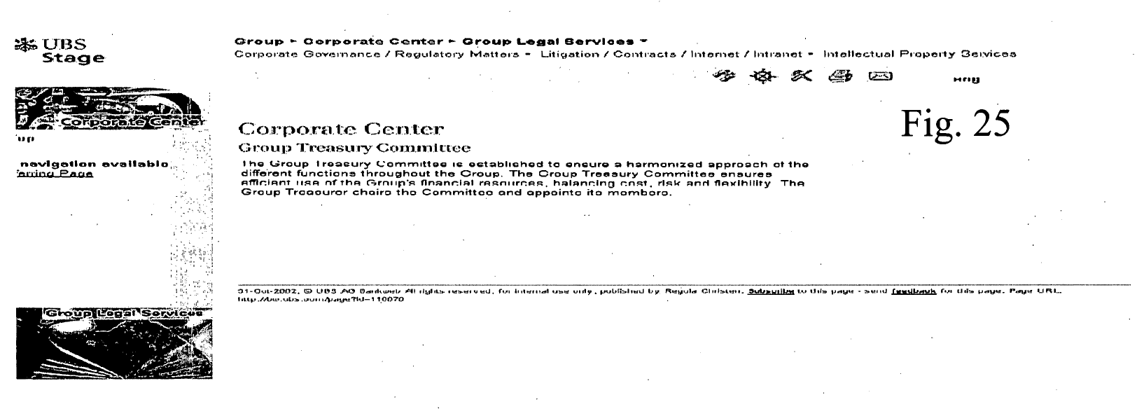

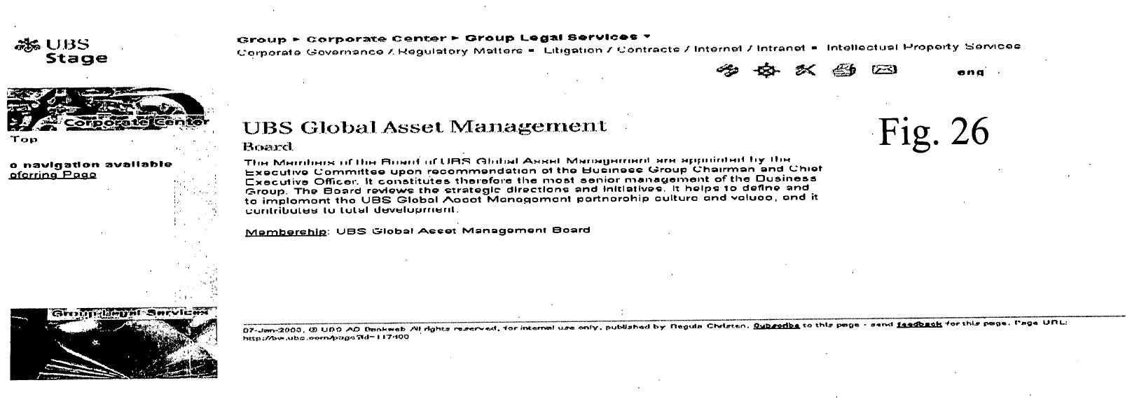

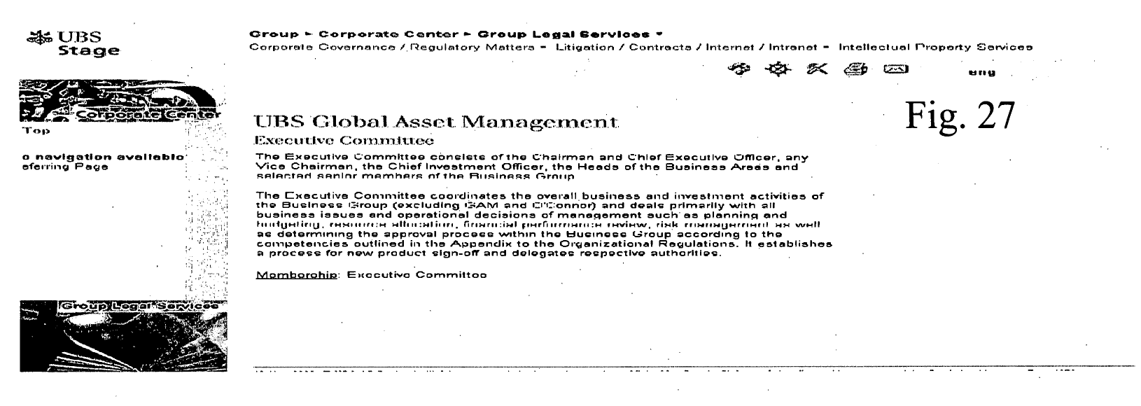

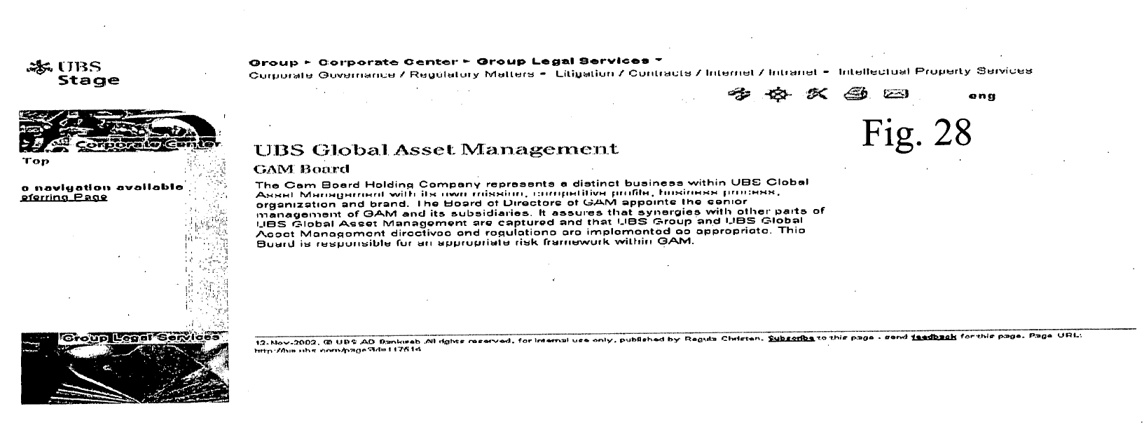

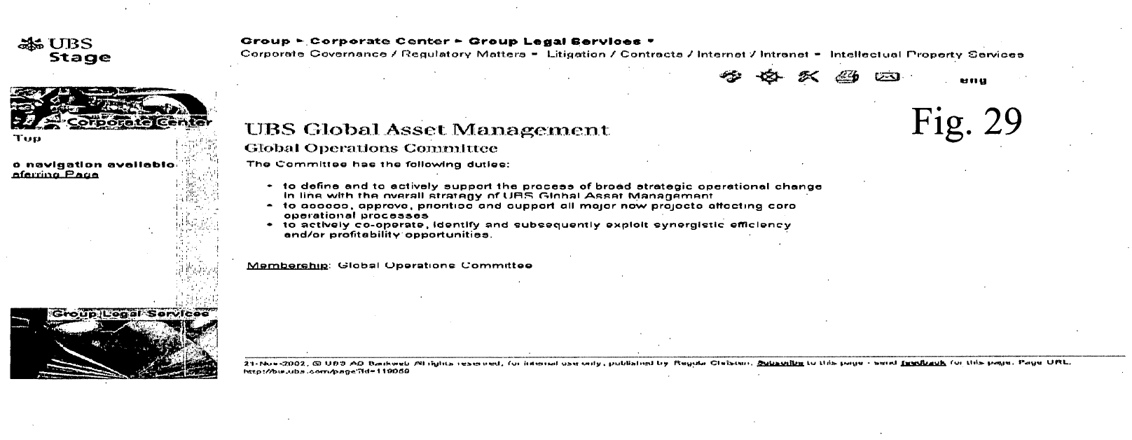

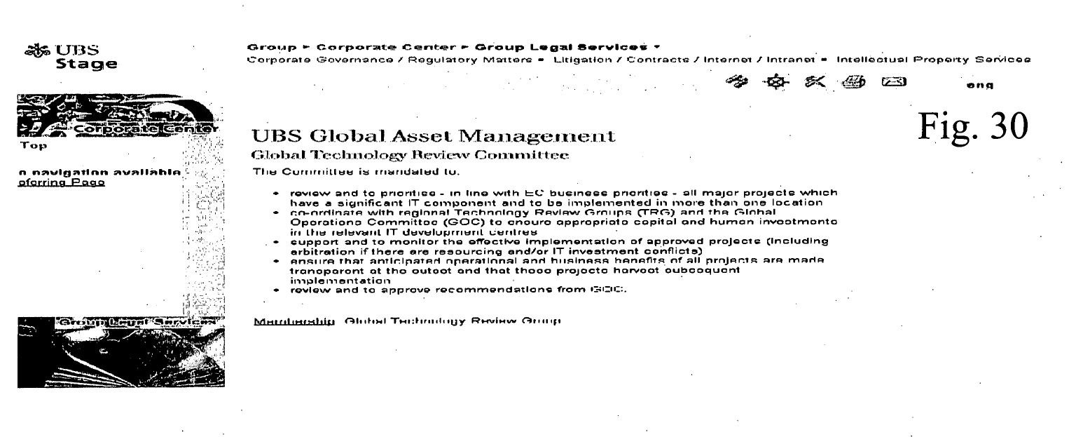

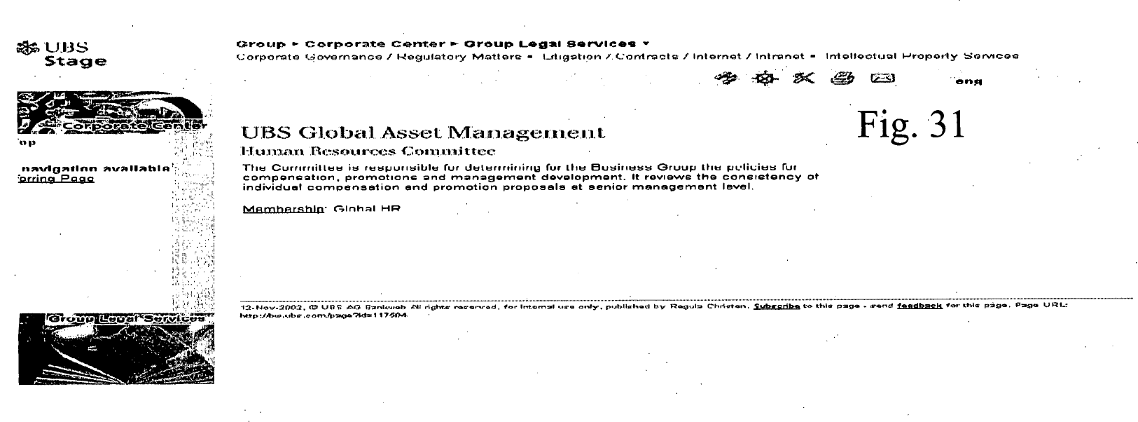

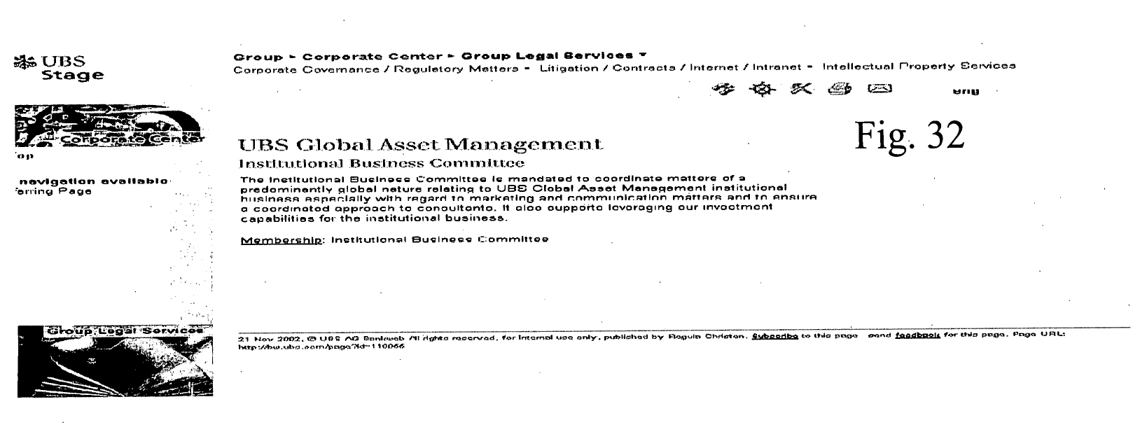

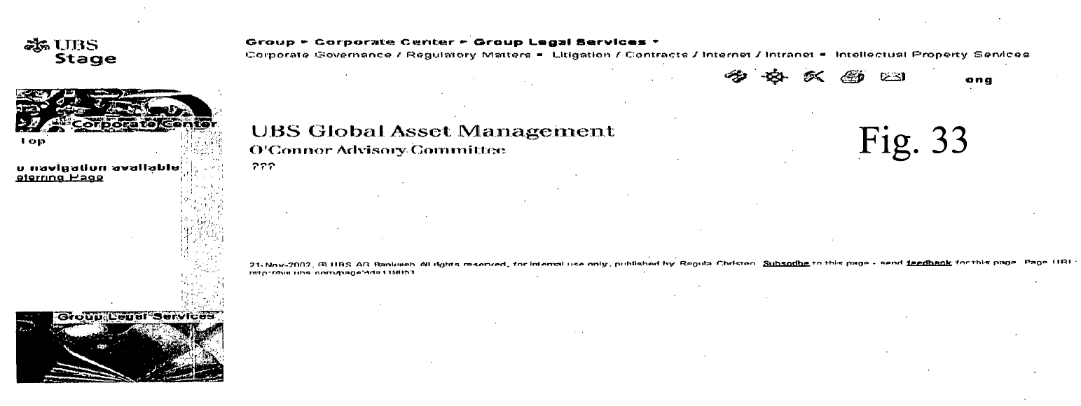

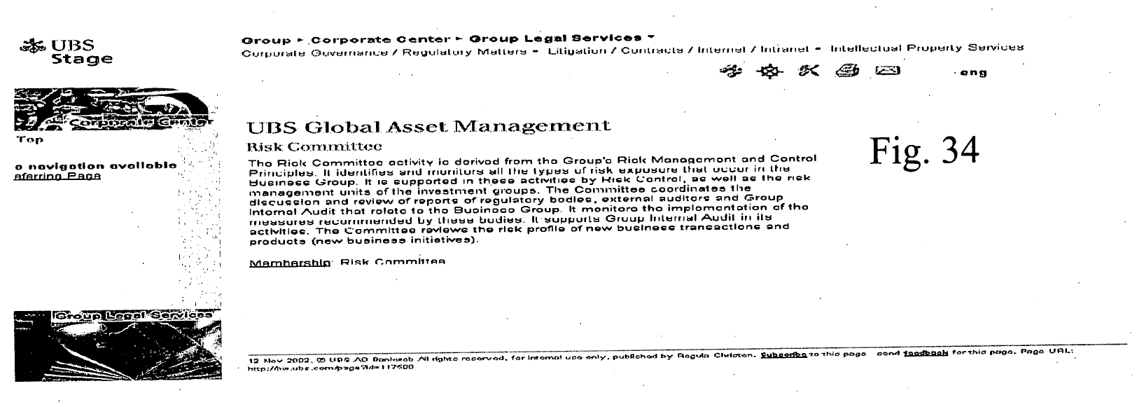

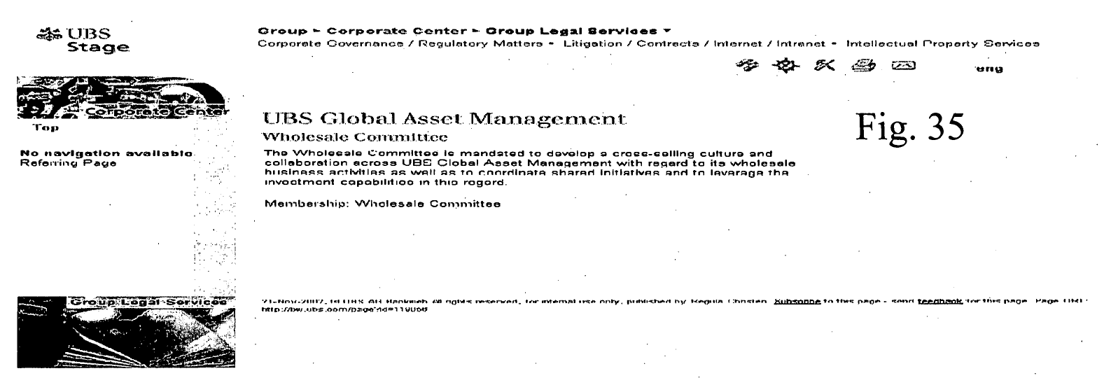

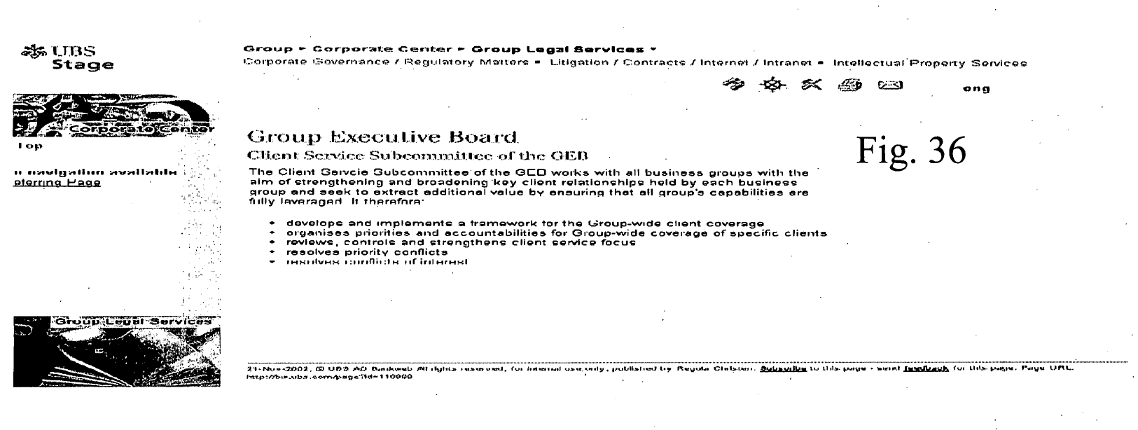

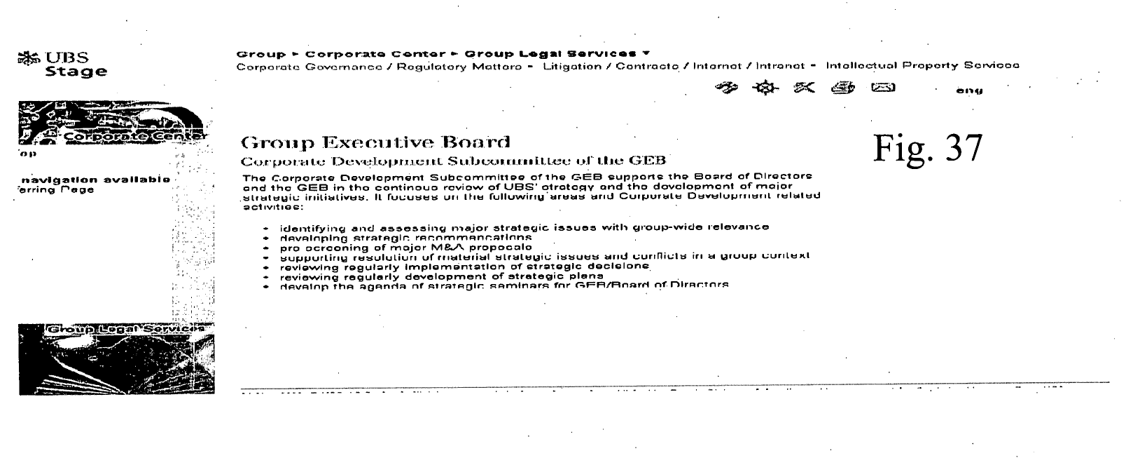

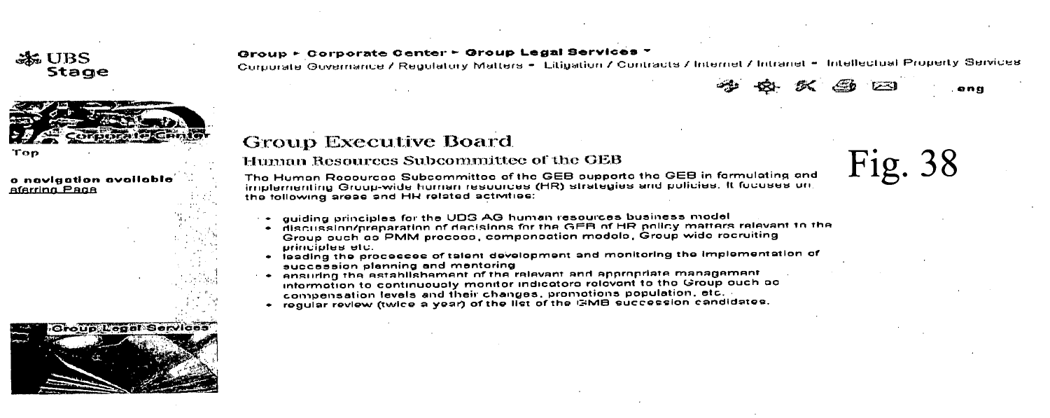

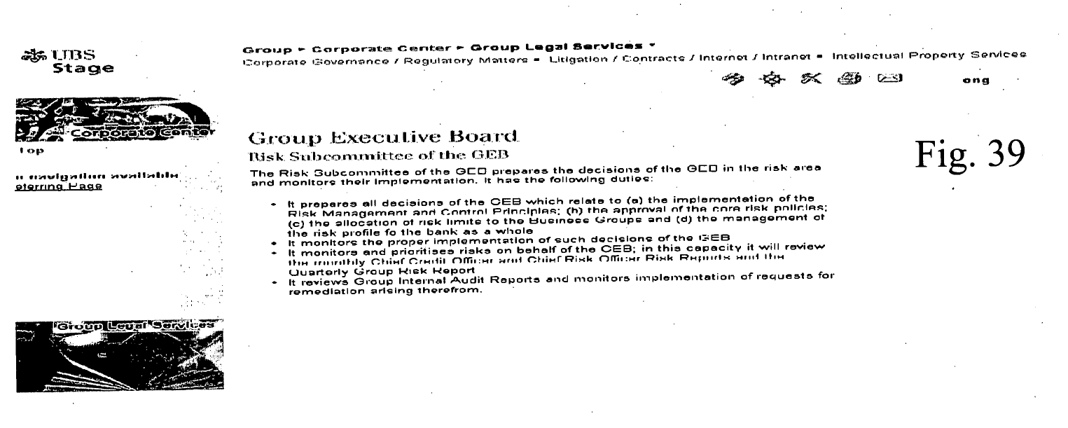

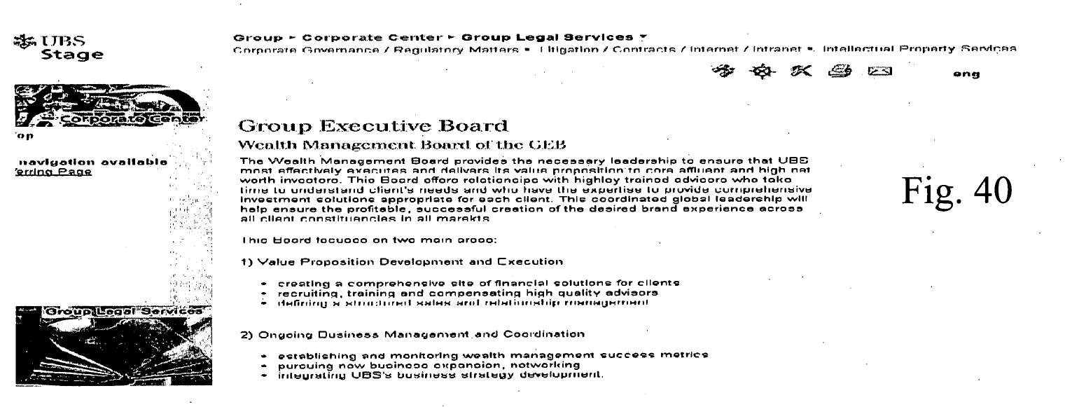

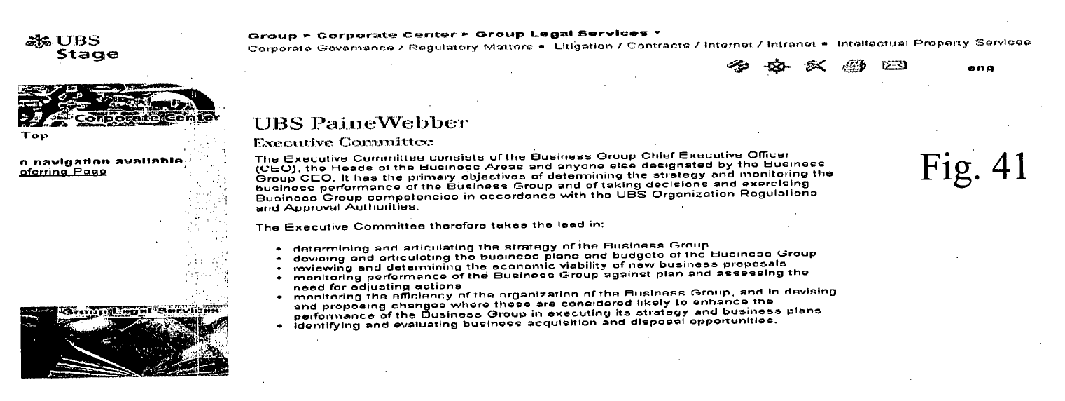

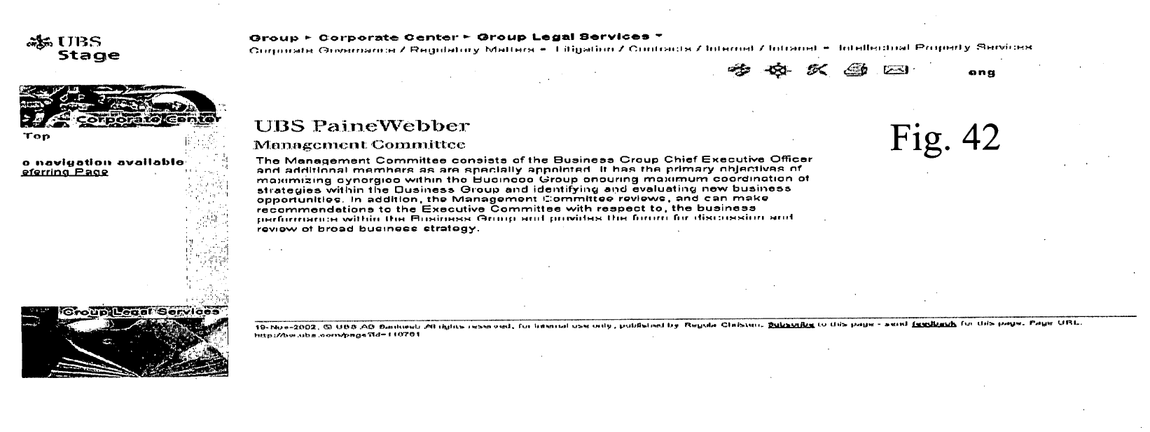

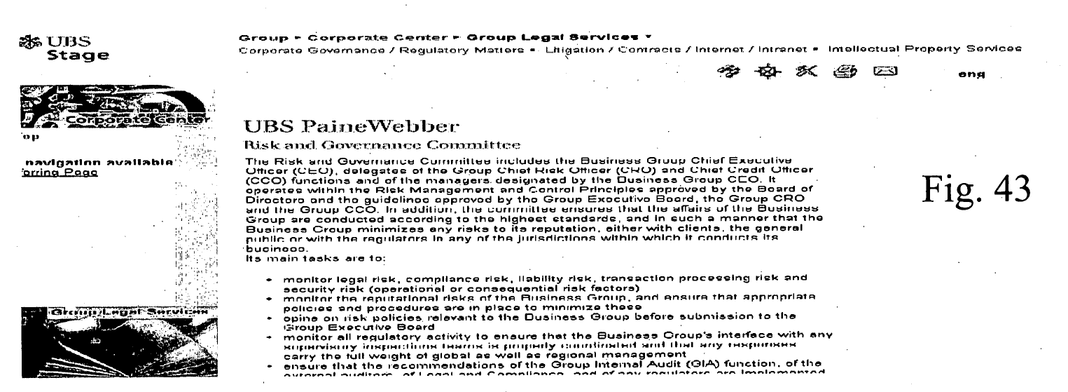

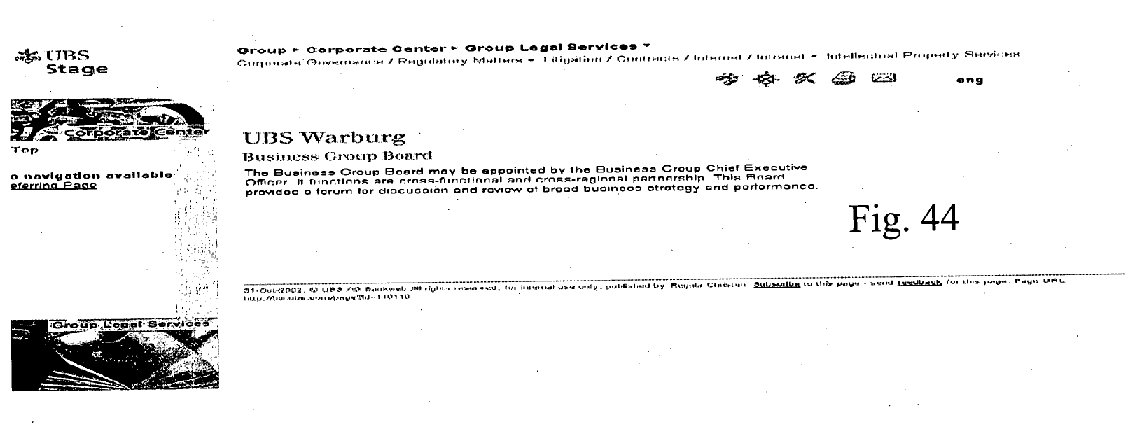

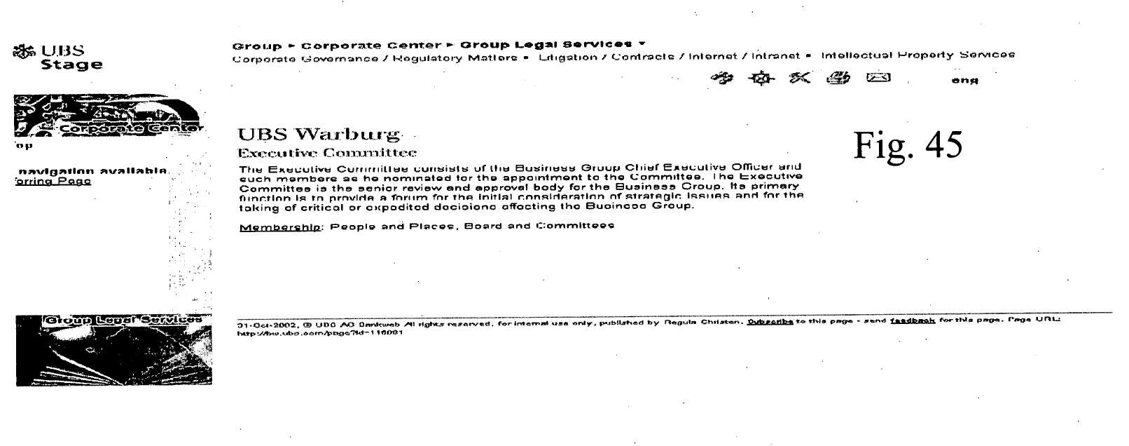

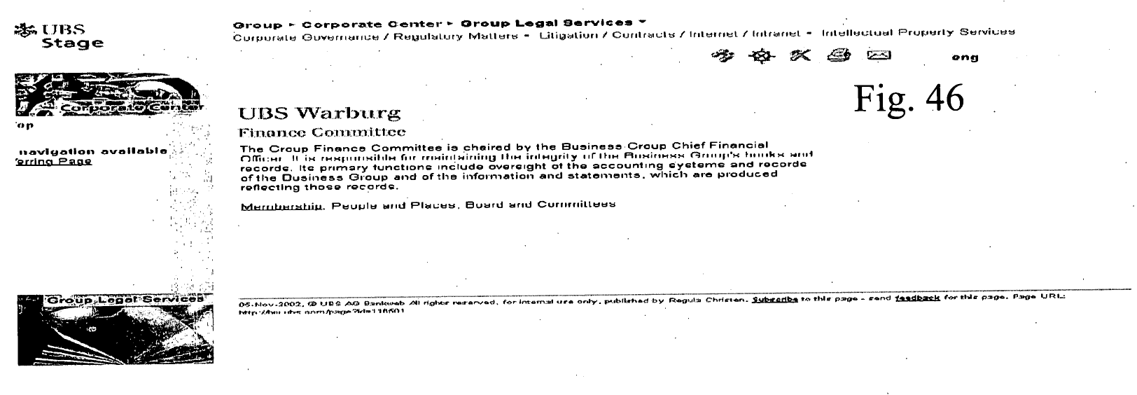

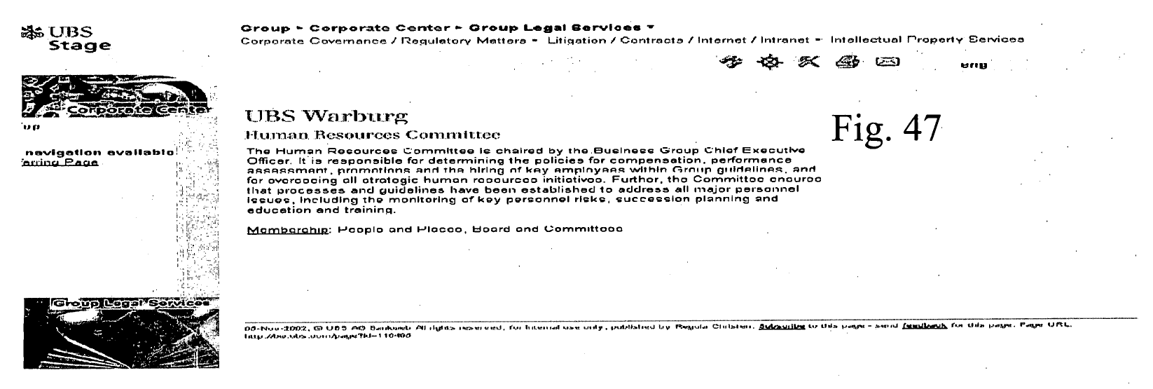

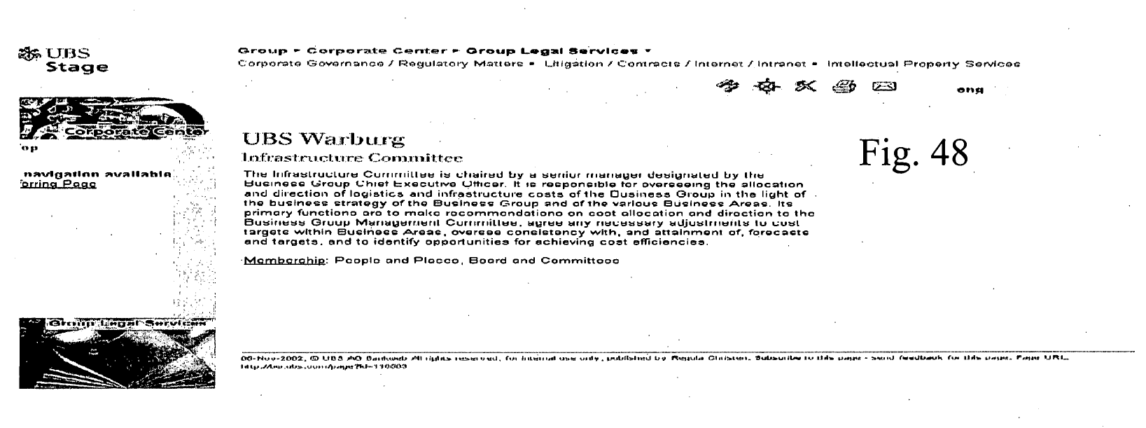

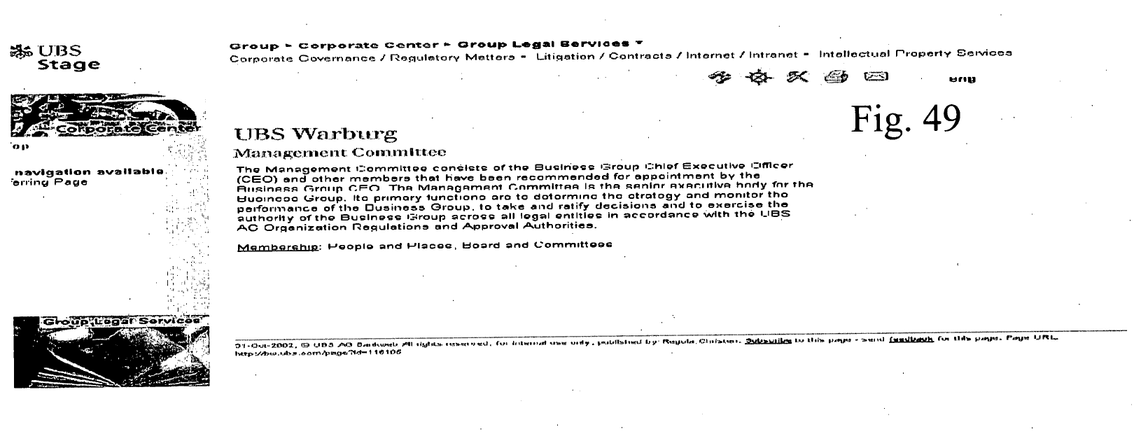

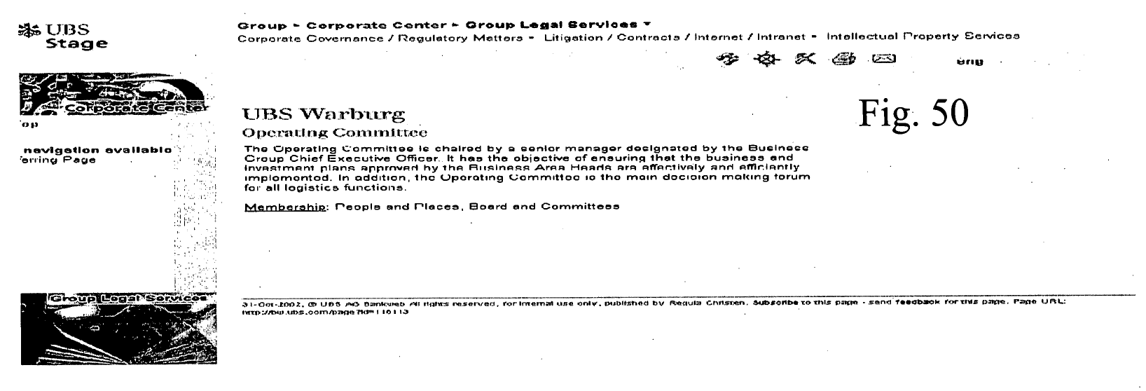

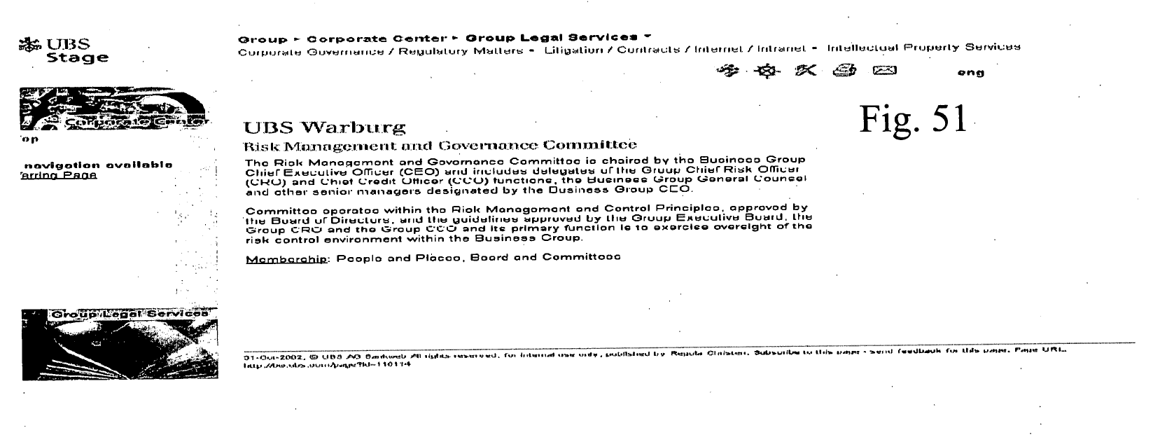

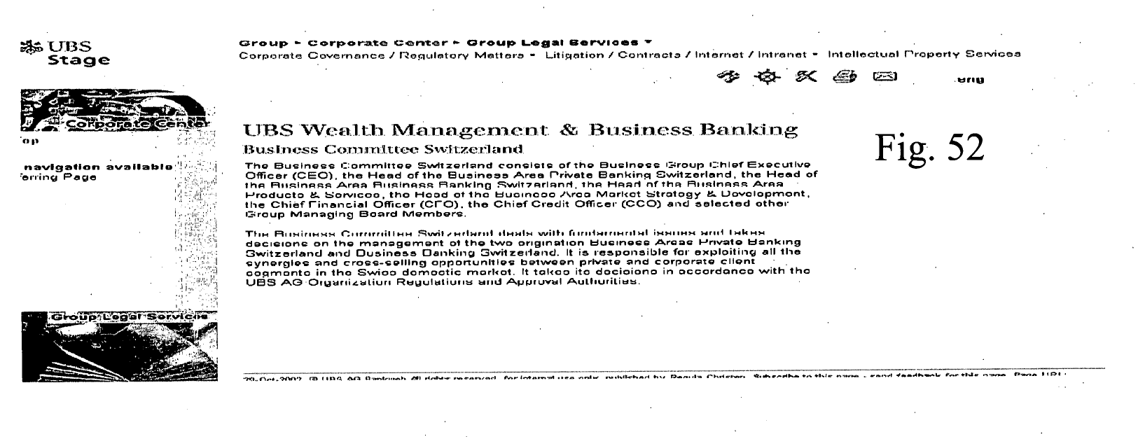

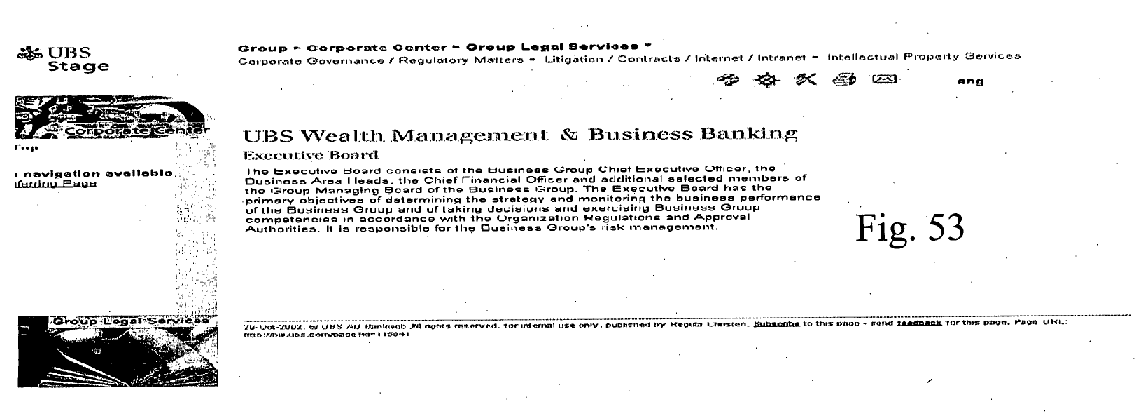

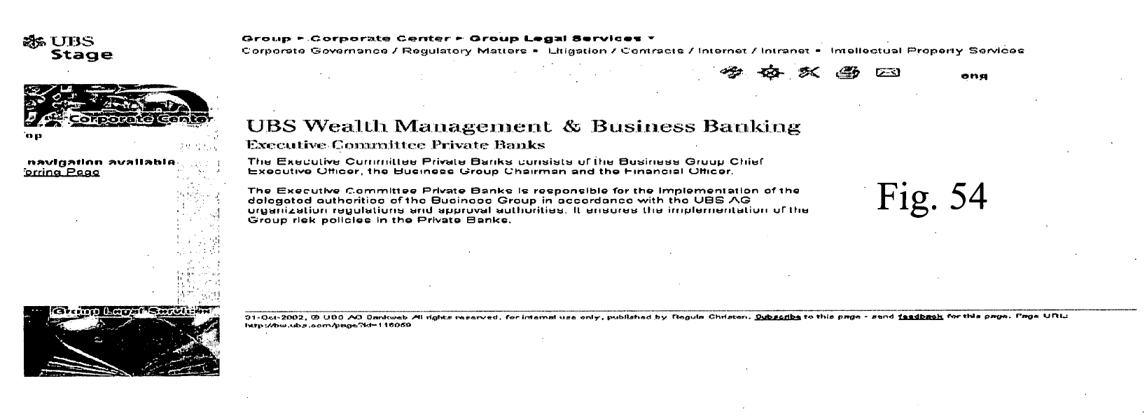

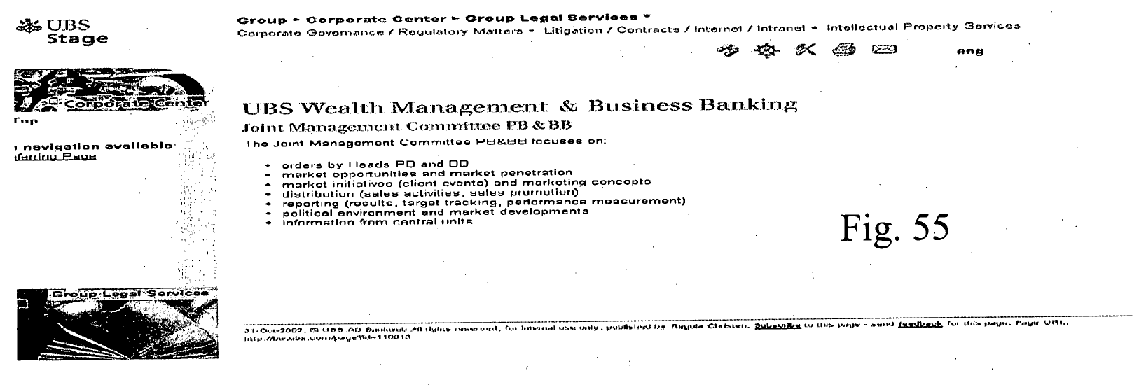

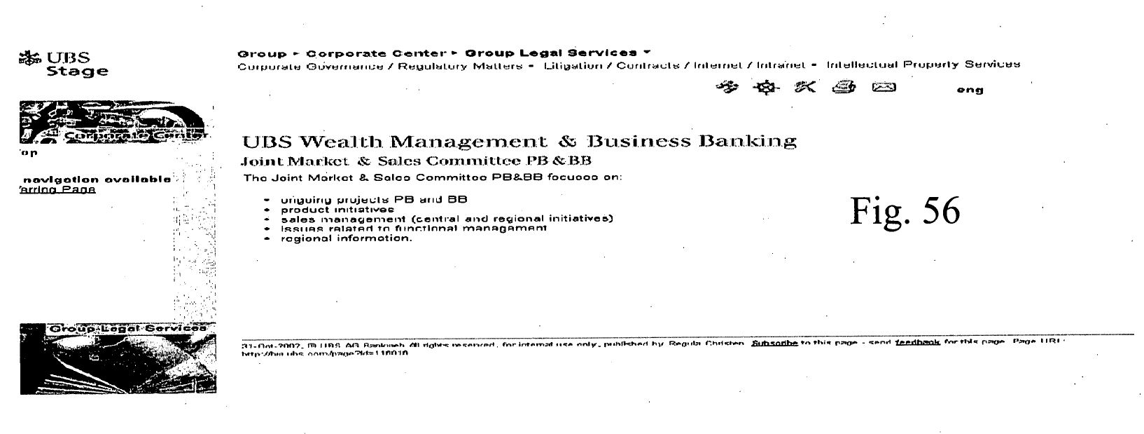

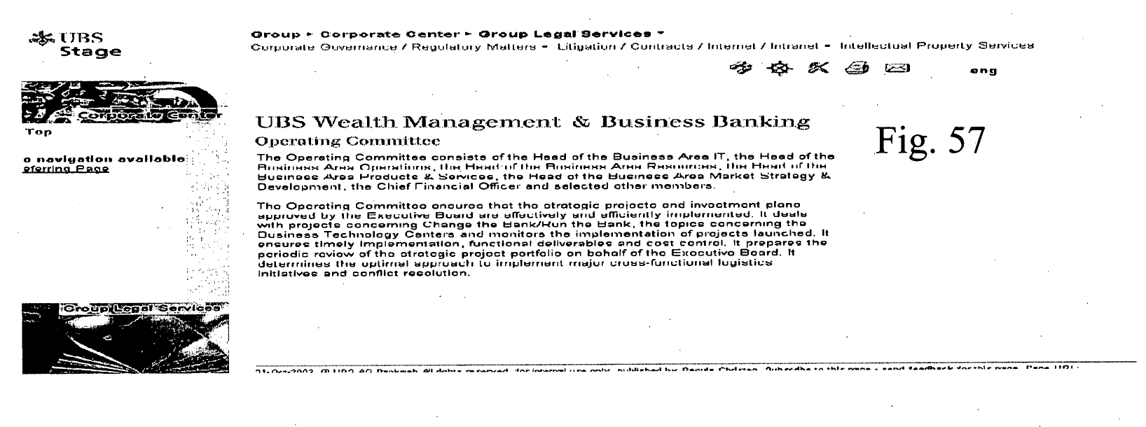

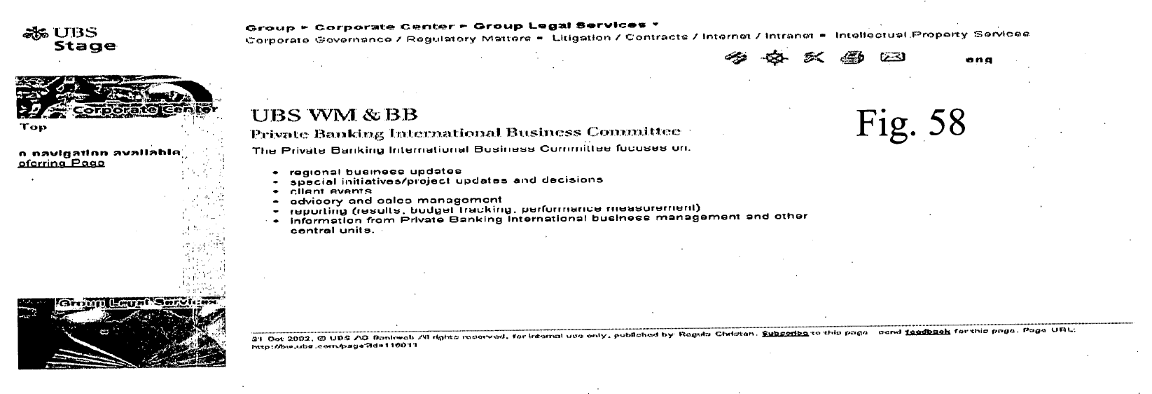

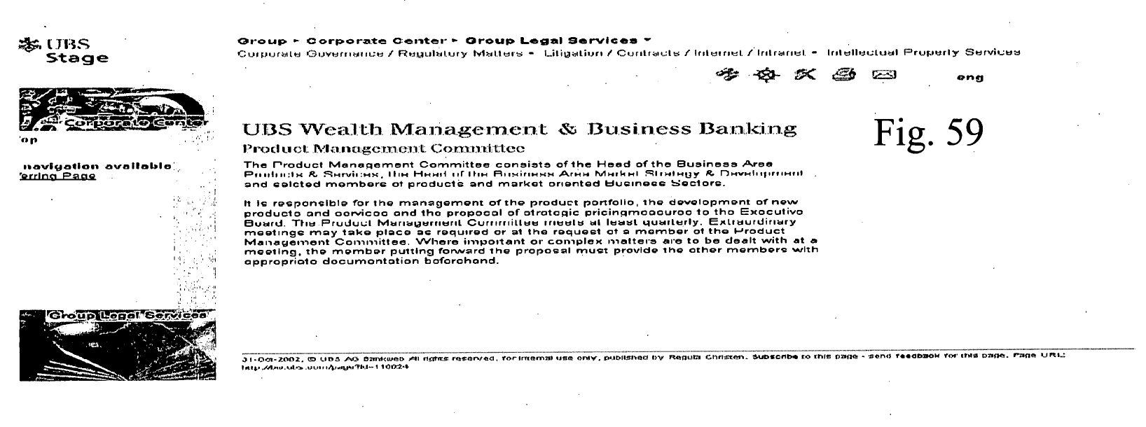

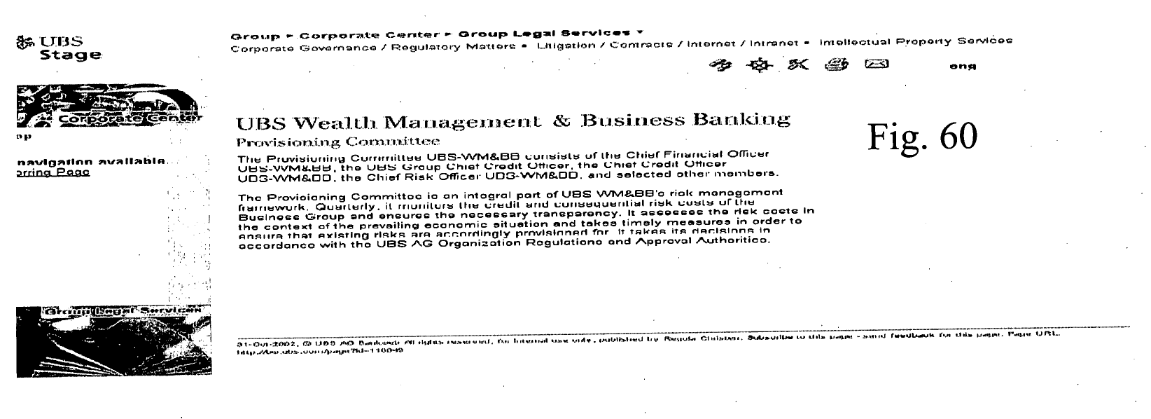

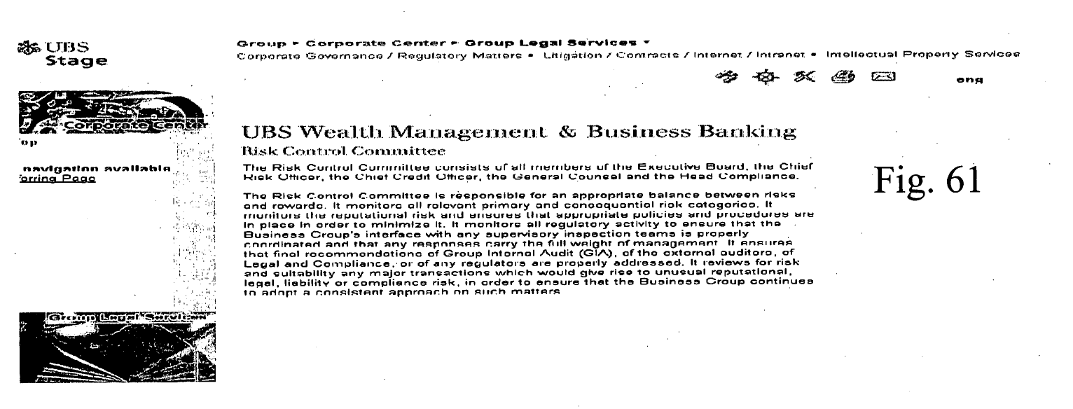

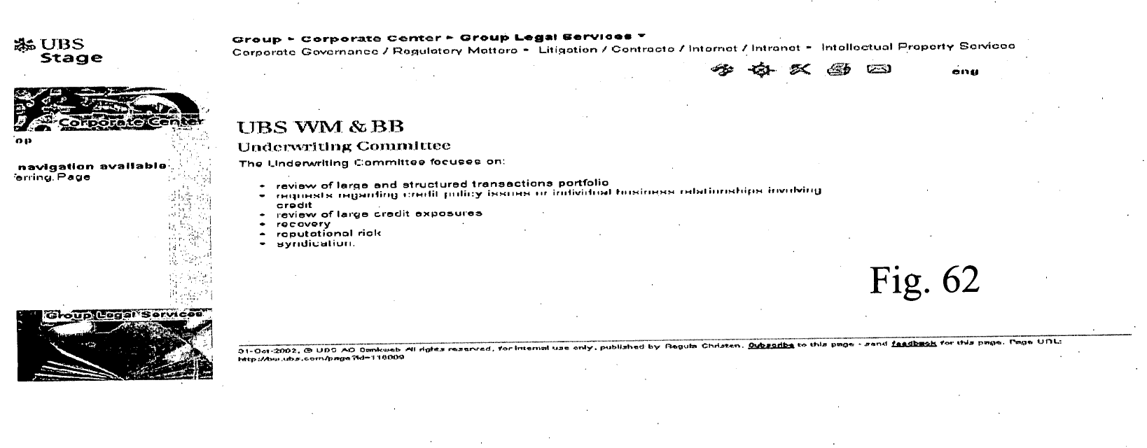

In the layer model, sites of the unified information platform are located in the content layer. Every page of a site of the unified information platform displays a global navigation that reflects its site type. This navigation can be either flat or hierarchical. As mentioned above, the electronic dossiers provided in the unified database are organized as a part of a collection of hierarchically organized pages forming a site describing a product, a service, a process, or an organizational unit. The site navigation reflects the organization/function/presentation of the product, the service, the process, or the organizational unit. This is also exemplified by pages of a site called “Regulations & Committees in UBS AG” (see FIGS. 7-62)

Available site types are:

| | |
|---|---|
| Organization site: | the home page of an organization, also called |
| | OU (organizational unit) site. |
| Service site: | a site describing a service or product. |
| Project site: | a site describing a larger project. |

OU sites have the hierarchical global navigation. Service sites should not feature an OU navigation since they are not necessarily related to a single organization. A meaningful global navigation here would be the set of related services. Projects can be classified and organized into subprojects, making it possible to display a hierarchical project navigation.

Sites of the unified information platform can reference each other with normal links within the page content.

In the layer model, inter-site navigation and search is provided in the access layer. This layer contains an extensible set of tools that allow a user to find and access sites or individual pages within these sites. A site browser combines site search and inter-site navigation functionality and can be accessed from every page. This corresponds in principle to a navigation window. The set of tools provided in the access layer is extensible.

The access layer facilitates the access of information on an intranet, but it does not process or bundle this information. A further step is to build a personalized view of the site of the unified information platform, which brings information from pages belonging to different sites together. This functionality is provided by the aggregation layer, which contains personalization and portal/knowledge management functionality.

The system provides a number of templates that can be utilized in the unified database (see FIG. 5). Before creating a page, the following items must be defined:

| | |
|---|---|
| Page title | For the title of the page. This is the name by |
| | which the unified database refers to the |
| | page in all searches. |
| Description for search | This is meta-information. When a search is done |
| | in the engines database and this |
| | page is found, this text will be shown. |
| | This field is required. |
| Keywords | Here keywords for the page can be entered |
| Language | A language for the page is chosen. |
| Page type | The page type is chosen. The choices are |
| | Standard, for normal pages, and |
| | News, for pages that are meant to be |
| | news articles. |
| Banners | This field controls wether the page layout |
| | should include a banner (a banner is a |
| | Title Block with a default banner graphic |
| | in it). |
| Layout 1-14 | One of the 14 standard layouts is chosen as a |
| | starting point for the page. |
| Contact page | If a Contact Page is created, this layout |
| | instead of one of the standard layouts is |
| | chosen. |

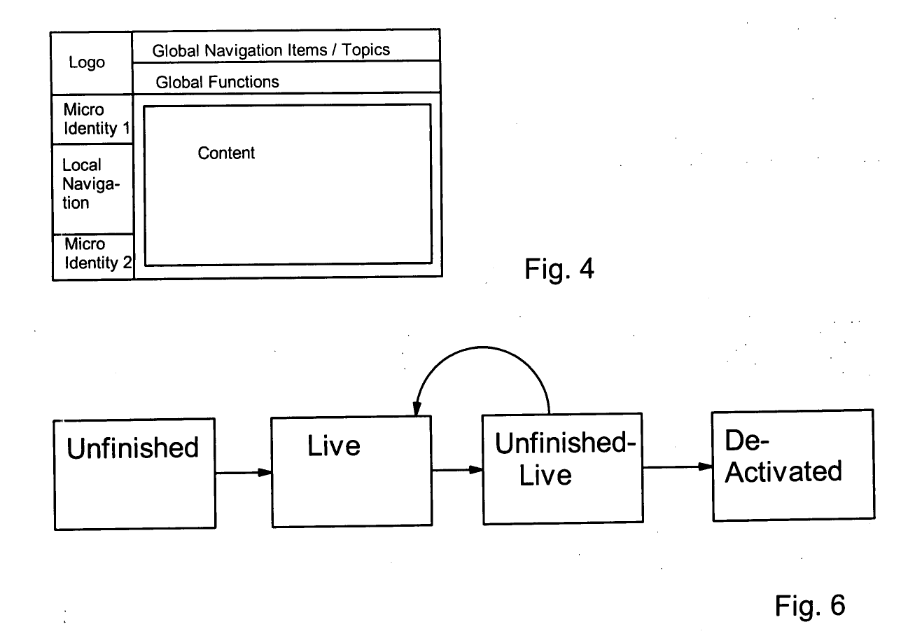

Each template of said predetermined set of templates is comprised of at least three distinct areas (see FIG. 4). By using one of the predefined templates of the predetermined set of templates, each of the pages is in line with the template rules. The pages have three distinct areas accessible through said GUI: a top area comprising at least one pointer for a global navigation path, and/or at least one pointer for a global topic; and/or at least one pointer for a global function; a local navigation area comprising at least one pointer for a local navigation path having a predetermined maximum hierarchical navigation depth, and/or at least one pointer for a local page of the web site, and/or at least one pointer for an page of an external web page, and/or at least one micro-identity area; and a content area having a predetermined layout according to said predetermined set of styles. This allows for a consistent appearance of the data to the user “look and feel” facilitating the navigation and retrieval of the contents by the users.

The style rules utilized to create and format the content include the text font, the font size and colors on pages on blocks and properties like titles, subtitles, text etc., adjusts spacing between elements like text lines, between text and graphic elements, define colors for backgrounds, and exclude the utilization of animations or the like.

A main design principle is that the basic unit of publishing is a paragraph. For every paragraph type, there is a dedicated editing functionality that hides most of the underlying markup code. An XML DTD (Document Type Definition) is defined for the page content which defines exactly what kind of markup is allowed in which paragraph. As an example, only the following XML tags are admitted and used:

| Tag | Description |
|---|---|
| <b>...</b> | Bold |
| <i>...</i> | Italic |
| <style id=“...”>...</style> | Applying a style (color, font, etc) |
| | to a predefined list of styles. |
| <br> | Line break |
| <p> | Paragraph |
| <space> | White space of a certain width. |
| <link type=“...”>...</link> | A link to a page. |
| <person...>...</person> | A person. |
| <email> </email> | An email address |
| <mobile...>...</mobile> | A handheld number. |
| <product...>˜..</product> | A product (account type, credit |
| | card, etc.) |
| <doc ref=“...”>...</doc> | A document |

The entirety of electronic dossiers forming a page, the entirety of pages forming a site, and the entireties of sites forming a platform are operated with clear interfaces, competences, and rules. To this end, several functions 52 having predetermined authorities, tasks and capabilities are provided (see FIG. 1):

a platform manager function

a web manager function

a site manager function

a publisher function

site owner function, and

an author function.

The platform manager function includes technical programming and development of the unified platform.

The web manager function includes publishing responsibilities for an entire business unit, including creation of web sites, definition of users, authorization of site managing functions and of publishing functions, accessing web sites with predefined restrictions in their business area, and providing information, data and support for publishing activities.

The site manager function includes allowing access to publishing functions of predefined sites, definition of local navigation, and ascertaining the compliance with said predetermined set of templates and/or said predetermined set of styles.

The publisher function includes the creation and formatting of pages of a web site, creation and insertion of local navigation pointers into pages of a web site, insertion of graphics on web pages, adding text on web pages, effecting changes and updates, defining and verifying links to pages, and publishing and de-activating pages.

The site owner function includes the responsibilities for the contents of the web site, effecting administrative duties including the definition of guidelines for the provision of a web page in certain languages, the publication format, and the period of validity of certain pages of a web site.

The author function includes the creation and/or provision of text and graphics, and provision of translations.

FIG. 6 shows a typical publishing cycle of a document on a web page of a unified network-based document database management system. The first status of a document on a web page is Unfinished. This is the status of a page or navigation that is new, and has never once been set live (or has been deactivated and restored). The second status of a document on a web page is Live. This is the status of a page or navigation that has been published. These pages and navigations are visible on the live site. The third status of a document on a web page is Unfinished-Live. This is the status of a page or navigation that has been edited. The live site continues to show the last Live version. The page or navigation is set Live again to ‘publish’ the changes. The status of a page or navigation that is under development and is tested usually changes between Unfinished-Live and Live. The fourth status of a document on a web page is Deactivated. This is the status of a page or navigation that has been deactivated. Once deactivated, it may be restored (set to Unfinished again) or permanently deleted.

FIGS. 7-62 show how the design principles explained above are put into practice in an actual web site.

The UBS Logo is presented in the top left corner.

The top area comprises several pointers for a global navigation path: Group>Corporate Center>Group Legal Services. Group Legal Services offers several topics: Corporate Governance/Regulatory Matters; Litigation/Contracts/Internet/Intranet; Intellectual Property Services. Further, pointers for global functions Search Navigator Tools Print Email are provided. Finally, the chosen language eng of the web site is indicated.

The local navigation area comprises the local navigation pointers if they are available. The local navigation has an entry called Top. This is the root navigation of the site. ToP is always linked to the welcome page of a site. Further, the local navigation area has two micro-identity areas representing Corporate Center and Group Legal Services.

The content area has a predetermined layout and refers to “Regulations and Committees in UBS AG.”

The design of the navigation is standardized. The colors, fonts, and spacing are all controlled by the system.

The navigations are hierarchical. There is a vertical and a horizontal hierarchy. Vertically, the Top navigation is always the first entry.

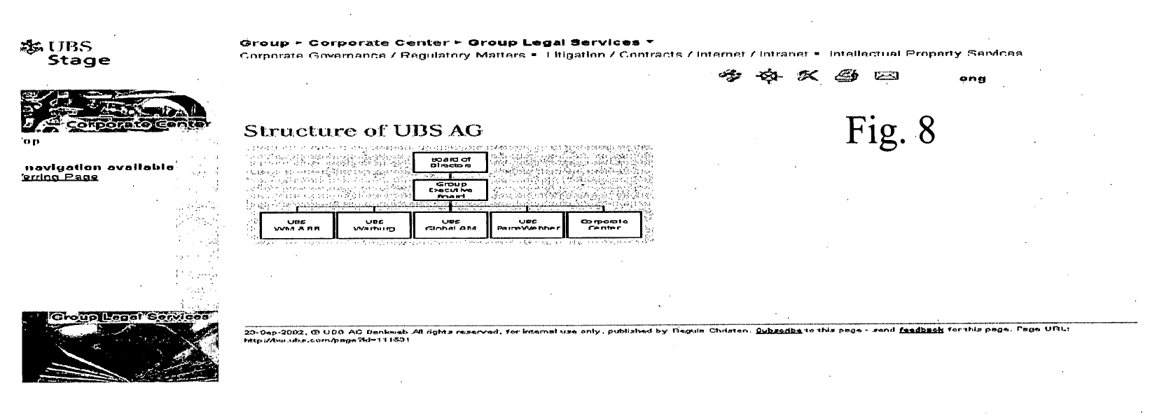

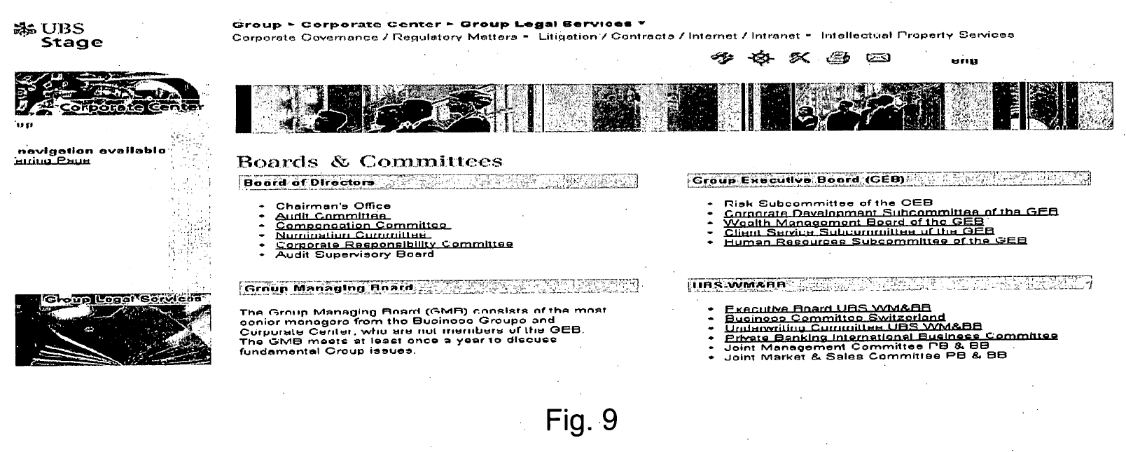

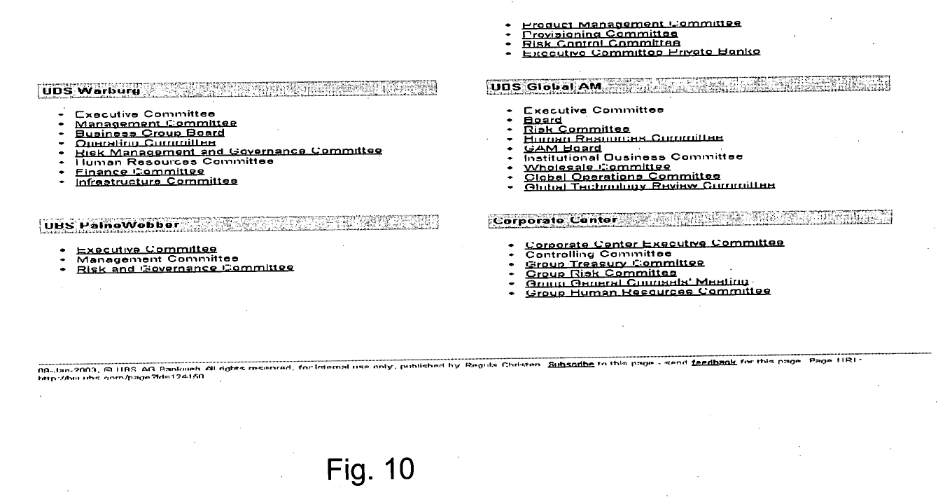

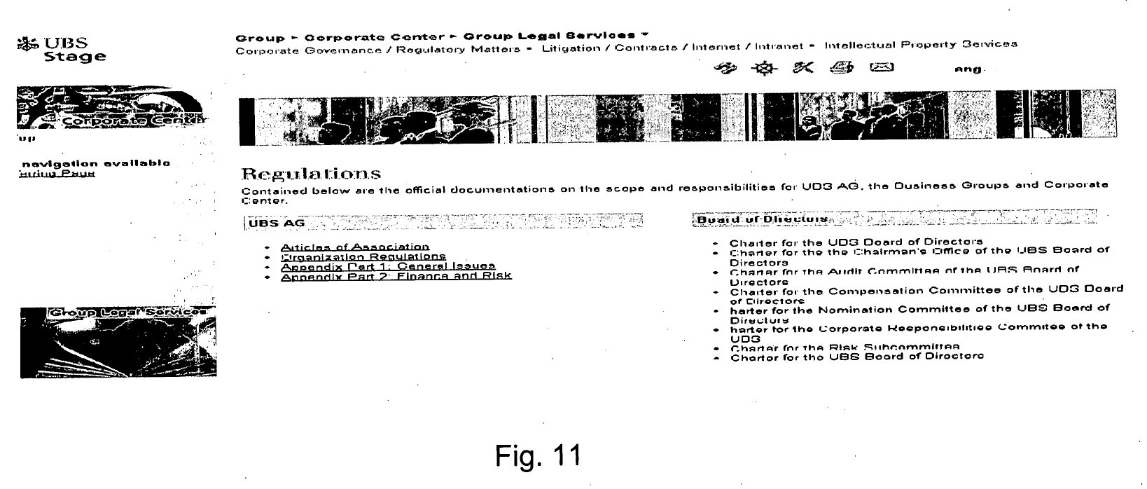

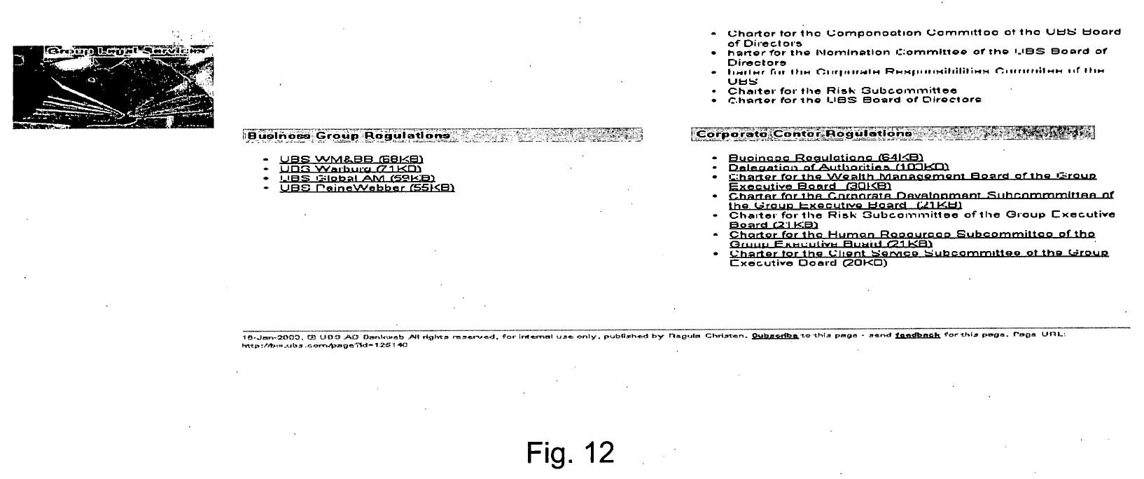

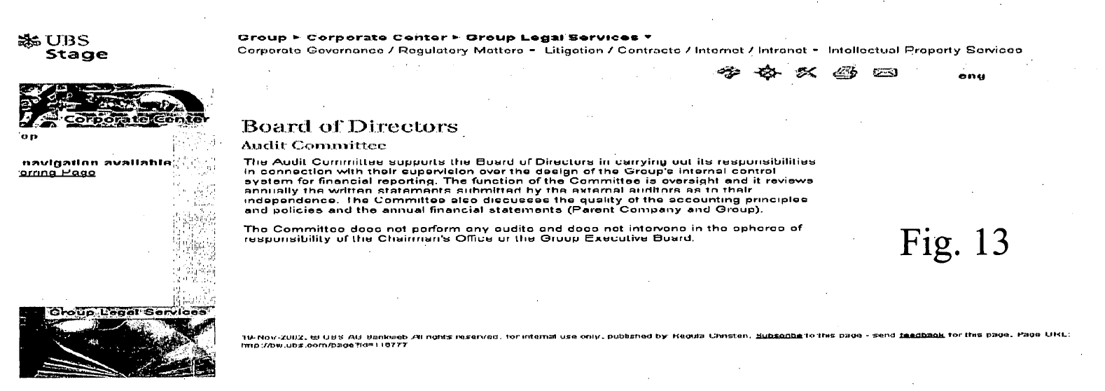

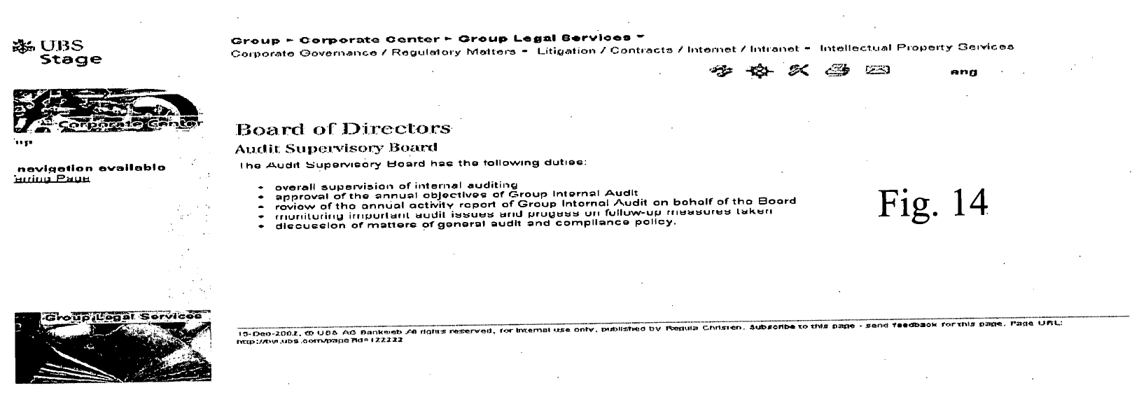

Linking to a wide variety of documents (PDF; WinWord, Excel, PowerPoint, Visio, etc.) is available by pointing with the mouse pointer to the Quick Links provided below the right hand image of FIG. 7. The Quick Links are POP-UP items pointing to Structure of UBS AG, Regulations, Board & Committees. Their appearance is shown in FIG. 8 (Structure of UBSAG), FIGS. 9-10 (Boards & Committees), and FIGS. 11-12 (Regulations). FIG. 10 is a continuation of the exemplary web page shown in FIG. 9. FIG. 12 is a continuation of the exemplary web page shown in FIG. 11. When the user follows a document link in the web pages of FIGS. 8-12, the document (e.g., a PDF) will open. The document must be either available via an intranet or reside on a web-server which is available to the unified database (i.e., it must have a URL). Clicking with the mouse pointer on Structure of UBSAGwill make FIG. 8 pop up. This presents the Structure of UBS AG having a Board of Directors, a Group Executive Board and five Business Units: UBS WM & BB, UBS Warburg, UBS Global AM, UBS PaineWebber, and Corporate Center The structure of UBS AG is reflected and presented by the structure of the web site as can be seen from the further pages shown in the following FIGS. 13-62. It can be followed and contemplated by working through the hierarchical web pages following the links and popup menus revealing links, documents, and information about UBS AG.

The above-described embodiments of the invention are intended to be examples of the present invention and alterations and modifications may be effected thereto, by those of ordinary skill in the art, without departing from the scope of the invention which is defined thoroughly by the claims appended hereto.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for managing electronic dossiers each having one of a plurality of document formats, wherein the electronic dossiers are accessible by a plurality of web site users via a computer network, the method comprising the steps of:
selecting an electronic dossier for conversion;
obtaining, from a predetermined set of templates, one template associated with the format of the electronic dossier;
obtaining, from a predetermined set of styles, at least a subset of style characteristics to be correlated to the format of the electronic dossier;
converting the electronic dossier to a document platform having a unified format;
storing the converted electronic dossier together with the obtained template and the obtained style subset in a unified database; and
providing access to the unified database to a plurality of users through a computer network browser interface in order to at least one of process, view, and store the converted electronic dossiers.

2. The method according to claim 1, wherein the electronic dossier format is chosen from the group consisting of: HTML pages, database content plus templates, static web pages, documents containing alphanumeric data, documents containing image data, links to other web sites, and XML documents.

3. The method according to claim 1, wherein the computer network comprises a number of groups maintaining different sets of document platforms.

4. The method according to claim 1, wherein each template of the predetermined set of templates is comprised of at least three distinct areas accessible through a graphical user interface, the distinct areas are chosen from the group consisting of:
a top area having at least one pointer chosen from the group consisting of: a pointer for a global navigation path, a pointer for a global topic, and a pointer for a global function;
a local navigation area having at least one pointer chosen from the group consisting of: a pointer for a local navigation path having a predetermined maximum hierarchical navigation depth, a pointer for a local page of the web site, and a pointer for an page of an external web page;
at least one micro-identity area; and
a content area having a predetermined layout according to the predetermined set of styles.

5. The method according to claim 1, wherein converting the electronic dossier to a unified format includes modifying at least one property of the electronic dossier chosen from the group consisting of: text font, font size, font color, page color, background color, titles, subtitles, element spacing, and multimedia content.

6. The method according to claim 1, wherein each of the electronic dossiers in the unified database is organized as a part of a collection of hierarchically organized pages forming a site describing at least one of a product, a service, a process, and an organizational unit.

7. The method according to claim 1, wherein converting the electronic dossier includes the conversion of the electronic dossier to XML format, and wherein content data within the electronic dossier is stored in the form of information blocks independent from one of the design and the layout of the content data.

8. The method according to claim 1, further comprising checking and verifying content data of the electronic dossier prior to its conversion for at least one of accuracy, timeliness, and relevance to the site.

9. The method according to claim 1, further comprising substituting a web page not existing in a certain requested language by an available language version of the web page according to a predefined priority scheme.

10. The method according to claim 1, further comprising:
receiving feedback information about one of a web page and a web site from a user;
routing the feedback information to a feedback database accessible by an administrator of the one of web page and a web site; and
entering the feedback information into the feedback database.

11. The method according to claim 1, further comprising providing web sites with access to an integrated image library, wherein the integrated image library has a hierarchical organization for distinguishing between images accessible by a plurality of websites and images accessible by a single website.

12. The method according to claim 1, further comprising:
determining whether links within the converted electronic dossier are valid based on their type;
determining whether the content data within the converted electronic dossier has expired;
determining whether the content data within the converted electronic dossier result in one of orphaned content data and orphaned sites; and
determining whether users attempt to access one of web pages and Web sites without proper authorization.

13. The method according to claim 1, further comprising:
scanning migrated electronic dossiers for extracting document related meta information; and
attaching the extracted document related meta information to a document for search and retrieval by users of the unified database.

14. A network component adapted to be connected to a plurality of members of a group of network components in a computer network for a unified network-based document management, comprising a hosting unit for hosting access by the group of network components of at least:
a first program code portion for generating one or more graphical user interfaces, one of the graphical user interfaces having at least a first control element for initiating a transformation of an electronic dossier originating from one of a number of document platforms, the electronic dossier being provided in a first format and being made available to a number of users of a web site; and
a second program code portion configured to:
obtain from a predetermined set of templates one template to be correlated to data of the electronic dossier;
obtain from a predetermined set of styles at least a subset of style characteristics to be correlated to the data of the electronic dossier,
migrate the electronic dossier to a document platform having a unified format, and
electronically export the electronic dossier together with the suited template and the style subset to a unified database, wherein the unified database is adapted to store the electronic dossier together with the obtained template and the obtained style subset and is accessible by a user by means of one of the network components through a browser interface by means of a browser installed on at least the one network component in order to at least one of process, view and store the electronic dossier.

15. The network component according to claim 14, wherein the document platform from which the electronic dossier originates is chosen from the group consisting of:
HTML pages, database content plus templates, static web pages, documents comprising alphanumeric data, documents comprising image data, links to other web sites, and XML documents.

16. The network component according to claim 14, wherein the computer network comprises a number of groups maintaining different sets of document platforms.

17. The network component according to claim 14, wherein each template of the predetermined set of templates is comprised of at least three distinct areas accessible through the one graphical user interface chosen from the group consisting of:
a top area comprising at least one pointer chosen from the group consisting of: a pointer for a global navigation path, a pointer for a global topic, and a pointer for a global function;
a local navigation area comprising at least one pointer chosen from the group consisting of: a pointer for a local navigation path having a predetermined maximum hierarchical navigation depth, a pointer for a local page of the web site, and a pointer for a page of an external web page;
at least one micro-identity area; and
a content area having a predetermined layout according to the predetermined set of styles.

18. The network component according to claim 14, wherein design rules utilized to create and format the migrated electronic dossier include text font, font size, font color, page color, background color, titles, subtitles, text, spacing between elements, and multimedia content.

19. The network component according to claim 14, wherein each of the electronic dossiers in the unified database is organized as a part of a collection of hierarchically organized pages forming a site describing one of a product, a service, a process and an organizational unit.

20. The network component according to claim 14, wherein each of the migrated electronic dossiers in the unified database uses XML as the unified format, and wherein content data is stored in the form of information blocks which are independent from one of the design and the layout of the content data.

21. The network component according to claim 14, further comprising a third program code portion for checking and verifying content of the electronic dossier prior to its migration to the document platform having the unified format with regard to at least one of accuracy, timeliness, and relevance to the web site.

22. The network component according to claim 14, further comprising at least one function chosen from the group consisting of:
a platform manager function, the platform manager function including technical programming and development of the unified platform,
a web manager function, the web manager function including publishing responsibilities for an entire business unit, including creation of web sites, definition of users, authorization of site managing functions and of publishing functions, accessing web sites with predefined restrictions in their business area, and providing information, data and support for publishing activities,
a site manager function, the site manager function including allowing access to publishing functions of predefined sites, definition of local navigation, and ascertaining the compliance with the predetermined set of templates and the predetermined set of styles,
a publisher function, the publisher function including the creation and formatting of pages of a web site, creation and insertion of local navigation pointers into pages of a web site, insertion of graphics on web pages, adding text on web pages, effecting changes and updates, defining and verifying links to pages, and publishing and deactivating pages,
a site owner function, the site owner function including responsibilities for the content of the web site, effecting administrative duties including the definition of guidelines for the provision of a web page in certain languages, the publication format, and the period of validity of certain pages of a web site, and
an author function, the author function including at least one of creation and provision of text and graphics, and provision of translations.

23. The network component according claim 14, further comprising a program code portion configured to effect a language management function that substitutes a web page not existing in a certain requested language by an available language version of this web page according to a predefined priority scheme.

24. The network component according to claim 14, further comprising a program code portion configured to:
receive feedback information about one of a web page and a web site from a user;
route the feedback information to a feedback database accessible by an entity responsible for the one of the web page and the web site; and
enter the feedback information into the feedback database.

25. The network component according to claim 14, further comprising a program code portion providing access of web sites to an integrated image library, with the integrated image library having a hierarchical organization allowing for the distinction of globally valid images from those that are to be used only within one site.

26. The network component according to claim 14, comprising a program code portion configured to:
check links depending on the link type;
determine if content data within one of the web pages and web sites has expired;
detect one of orphaned content data and orphaned sites; and
detect accounts of users trying to access one of web pages and web sites without authorization.

27. The network component according to claim 14, further comprising a program code portion configured to:
scan migrated electronic dossiers for extracting document related meta information; and
attach the extracted document related meta information to a document for search and retrieval by users of the unified database.

28. A computer database product for a unified network-based document management, comprising at least one electronic dossier originating from a document platform, each of the dossiers being provided in a unified format together with at least a subset of style characteristics of a predetermined set of styles to be correlated to data of the electronic dossier, and one template of a predetermined set of templates to be correlated to data of the electronic dossier, and wherein the electronic dossiers are accessible by a user by means of a network component through a browser interface by means of a browser installed on the network component in order to at least one of process, view, and store the electronic dossiers.

29. A system for managing electronic dossiers each having one of a plurality of document formats, wherein the electronic dossiers are accessible by a plurality of users via a computer network, the system comprising:
a selection unit for selecting an electronic dossier for conversion;
a template unit for obtaining from a predetermined set of templates one template associated with the format of the electronic dossier;
a style unit for obtaining from a predetermined set of styles at least a subset of style characteristics to be correlated to the format of the electronic dossier;
a conversion unit for converting the electronic dossier to a document platform having a unified format; and
an importing unit for importing the converted electronic dossier together with the obtained template and the obtained style subset into a unified database, wherein the unified database is adapted to store the converted electronic dossier together with the obtained template and the obtained style subset and is accessible through a computer network browser interface in order to at least one of process, view and store the converted electronic dossiers.

30. A system for managing electronic dossiers each having one of a plurality of document formats, wherein the electronic dossiers are accessible by a plurality of users via a computer network, the system comprising:
selection means for selecting an electronic dossier for conversion;
first means for obtaining from a predetermined set of templates one template associated with the format of the electronic dossier;
second means for obtaining from a predetermined set of styles at least a subset of style characteristics to be correlated to the format of the electronic dossier;
conversion means for converting the electronic dossier to a document platform having a unified format; and
database means for storing the converted electronic dossier together with the obtained template and the obtained style subset accessible through a computer network browser interface in order to at least one of process, view and store the converted electronic dossiers.

31. A method for document management comprising the step of providing one or more graphical user interfaces (GUIs), one of the graphical user interfaces (GUIs) including:
a first control element for initiating a conversion of an electronic dossier originating from one of a number of document platforms, wherein the electronic dossier is provided in a first format and is made available to a number of users of a web site; and
a second control element for:
obtaining from a predetermined set of templates one template to be correlated to data of the electronic dossier;
obtaining from a predetermined set of styles at least a subset of style characteristics to be correlated to the data of the electronic dossier;
migrating the electronic dossier to a document platform having a unified format; and
electronically exporting the electronic dossier together with the suited template and the style subset to a unified database, wherein the unified database is adapted to store the electronic dossier together with the obtained template and the obtained style subset and is accessible through a computer network browser interface in order to at least one of process, view and store the electronic dossiers.

32. A computer system for managing electronic dossiers each having one of a plurality of document formats, wherein the electronic dossiers are accessible by a plurality of web site users via a computer network, the system comprising a processor and a memory coupled to the processor, the memory encoding at least one program, the at least one program causing the processor to:
select an electronic dossier for conversion;
obtain from a predetermined set of templates one template associated with the format of the electronic dossier;
obtain from a predetermined set of styles at least a subset of style characteristics to be correlated to the format of the electronic dossier;
convert the electronic dossier to a document platform having a unified format; and
store the converted electronic dossier together with the obtained template and the obtained style subset in a unified database; and
provide access to the unified database to a plurality of users through a computer network browser interface in order to least one of process, view, and store the converted electronic dossiers.

33. A computer system for managing electronic dossiers each having one of a plurality of document formats, wherein the electronic dossiers are accessible by a plurality of web site users via a computer network, the system comprising a processor and a memory coupled to the processor, the memory encoding at least one program, the at least one program causing the processor to:
select an electronic dossier for conversion;
obtain from a predetermined set of templates one template associated with the format of the electronic dossier;
obtain from a predetermined set of styles at least a subset of style characteristics to be correlated to the format of the electronic dossier;
convert the electronic dossier to a document platform having a unified format; and
store the converted electronic dossier together with the obtained template and the obtained style subset in a unified database; and
provide access to the unified database to a plurality of users through a computer network browser interface in order to at least one of process, view, and store the converted electronic dossiers.

34. A computer program product comprising program code portions for execution on at least one component of a computer network, the program code portions controlling the at least one component of the computer network to manage electronic dossiers each having one of a plurality of document formats, wherein the electronic dossiers are accessible by a plurality of web site users via a computer network, the computer program product including:
first code portions for selecting an electronic dossier for conversion;
second code portions for obtaining from a predetermined set of templates one template associated with the format of the electronic dossier;
third code portions for obtaining from a predetermined set of styles at least a subset of style characteristics to be correlated to the format of the electronic dossier;
fourth code portions for converting the electronic dossier to a document platform having a unified format; and
fifth code portions for storing the converted electronic dossier together with the obtained template and the obtained style subset in a unified database; and
sixth code portions for providing access to the unified database to a plurality of users through a computer network browser interface in order to at least one of process, view, and store the converted electronic dossiers.

35. A method for providing web site users with access to an electronic dossier containing data, the method comprising:
receiving a request to access the electronic dossier, the electronic dossier originating from a first document platform;
determining a template suitable for the data of the electronic dossier;
determining style characteristics suitable for the data of the electronic dossier;
converting the electronic dossier into a second document platform;
associating the converted electronic dossier with the template and the style characteristics; and
providing the web site users with access to the converted electronic dossier in accordance with the template and the style characteristics, wherein the access is provided through a computer network browser interface.

36. The method of claim 35, wherein the second document platform is XML.

37. The method of claim 35, wherein associating comprises storing the electronic dossier with the template and the style characteristics in a unified database.

38. The method of claim 35, wherein associating comprises storing, in a unified database, the electronic dossier along with a pointer to a storage location of the template and a storage location of the style characteristics.

39. The method of claim 35, further comprising defining an XML Document Type Definition for the data.

40. The method of claim 35, further comprising limiting the data of the electronic dossier to a paragraph, wherein multiple electronic dossiers form a web page.
